(19) United States
(12) Patent Application Publication
(10) Pub. No.: US 2023/0410056 A1
(43) Pub. Date: Dec. 21, 2023

(54) COMPREHENSIVE CASE MANAGEMENT SYSTEM WITH COMPLIANCE DETECTION

(71) Applicant: Pilar Teresa Campbell, Clovis, CA (US)

(72) Inventor: Pilar Teresa Campbell, Clovis, CA (US)

(21) Appl. No.: 17/664,831

(22) Filed: May 24, 2022

(51) Int. Cl. G06Q 10/10

(52) U.S. Cl. CPC G06Q 10/1057; G06Q 10/1095

(57) ABSTRACT

The present disclosure relates to a comprehensive case management system operating under a single platform for coordinating and managing injury cases between a multitude of parties including but not limited to employees, professional groups, and agencies in order to 1) streamline and integrate the processing and tracking of worker compensation claims initiated by employees; and 2) analyze, process, and determine non-compliance of such claims.

### FIELD OF THE INVENTION

The present disclosure relates to a comprehensive case management system operating under a single platform for coordinating and managing injury cases between a multitude of parties including but not limited to employees, professional groups, and agencies in order to 1) streamline and integrate the processing and tracking of worker compensation claims initiated by employees; and 2) analyze, process, and determine non-compliance of such claims. In addition, the system may generate a non-compliance report having non-compliance data analyzed by a compliance detection module that determines compliance based on AMA guidelines or applicable legal statutes. Moreover, the non-compliance report may be transmitted in real-time to the relevant parties, including third party adjusters, to help determine a final decision and outcome of all pending claims.

### BACKGROUND

Workers' Compensation (“WC”) and Personal Injury (“PI”) claims typically involve multiple parties with distinct legal interests. These claims may involve an injury that occurs at the workplace and/or during work hours. A proper resolution to such claims critically depends on the accurate reporting and accessibility of key information, including medical information, about the subject injury and claim. The current WC landscape does not offer a reliable way of accessing, streamlining and utilizing this key information. Importantly, WC and PI claims are evaluated to determine temporary or permanent impairment on an injured claimant under the American Medical Association's (AMA) Guidelines (Guides). The AMA Guides require physicians to evaluate injured claimants to make specific findings that are used to determine an amount of temporary or permanent impairment the claimant has suffered as a result of the injury. The amount of temporary or permanent impairment is used as a basis for a claim settlement, and so this information must be as accurate and accessible as possible in order to render it useful.

Unfortunately, the AMA Guides are vast and the medical reports written by examining physicians are not always accurate or compliant with the AMA Guides. Insurance adjusters are plagued with heavy caseloads making it very difficult and taxing for them to do an analysis as to whether the medical reports they are reviewing, for purposes of determining the amount of temporary or permanent impairment, are accurate and in compliance with the AMA Guides. If the value of the case is considered low, the insurance company may provide a settlement based on their best guess of the AMA Compliance of the medical reports. If the value is considered high, the insurance company may initiate an additional compliance review. This typically has a high cost associated with it, and requires several days (if not weeks) for the review to be completed. However, even these additional reviews may be performed on a best guess basis and are not based on an actual understanding of the compliance of the medical reports. The insurance provider typically does not have the capability or time needed to do a complete AMA compliance analysis. As a result, the insurance processing time may be very long and the claim settlements may not reflect the true value of the claim. Moreover, inaccurate claim values may hinder a given insurance (or third party adjuster) company's ability to properly earmark cash reserves that are used to pay out injury claims.

Furthermore, third party adjusters often provide benefits under a claim (including for temporary disability, permanent disability, and/or mileage) when such benefits are not legally warranted or compliant under applicable law. This is typically due to a misapplication or failure to streamline or access the relevant criteria, including threshold compensability of a claim, wage information regarding the injured employee and reporting details of the primary treating physician. Clear access and organization of these criteria, as well as associated compliance detection, would give third party adjusters the confidence that they are providing benefits properly due to the injured employee under applicable law.

### DESCRIPTION OF THE RELATED ART

Systems aimed at facilitating injury claims have not fully or comprehensively addressed the issues described herein. For example, some of the prior art focuses only on identifying inaccurate injury impairment ratings without accounting for or identifying key data and metrics that led to the faulty claim value in the first place. That is putting the cart before the horse. Other prior art fails to account for AMA compliance altogether, or focuses on injury claims management only from the standpoint of the employer. Other prior art focuses only on medical injury profiling to benefit physicians when they submit insurance reimbursement, which is a separate issue in and of itself. Other prior art focuses on managing injury claims amidst a constantly changing legislative landscape, but still fails to address issues that specifically plague WC and PI claims. The prior art also fails to assess AMA/medical compliance in conjunction with legal/statutory compliance, when it is clear that discrepancies in either category could be a rate-limiting step to efficiently and properly resolving an injury claim as a whole.

Therefore, it is desirable to have a system and method of performing, handling, and streamlining WC and PI claims for all involved parties, including by determining AMA and legal compliance of worker's compensation and benefits, and while residing in a complex working environment, providing fast, efficient, and accurate processing methods that overcome the problems associated with conventional methods.

### SUMMARY

In an exemplary embodiment, information regarding a Workers' Compensation claim, including medical information, is received by application modules representing the relevant parties to a claim. An optimized medical report is generated from received medical information. The optimized report is used to determine non-compliance indicators reflecting discrepancies from what is provided for in the AMA guidelines. The non-compliance indicators are used to generate a value or level of findings associated with the received medical information. In another embodiment, one or more of the discrepancies triggering the non-compliance indicators are corrected and a second value of findings is determined to help understand the value of a Workers' Compensation claim. Other parameters or values are also determined including total impairment parameters or values.

It is an advantage of the present disclosure to provide a comprehensive and dynamic case management system operating under a single platform for coordinating, tracking and managing worker's compensation cases. In particular, the system may include a network communication link; a network interface coupled to the communication link; a processor coupled to the communication link; a memory device coupled to the communication link and holding an instruction set executable on the processor to cause the system to: initiate a workers' compensation session, hosted by a case management server having a plurality of application modules, over a network; receive a plurality of workers' compensation data from one or more parties by the case management server, over the network; aggregate the plurality of workers' compensation data to form an optimized report by the case management server; analyze the optimized report by one or more compliance detection modules; generate a compliance report based on medical guides or legal statutes by the one or more compliance detection modules; and determine a first value of findings based on existing non-compliance indicators obtained from the compliance report and a second value of findings based on corrected non-compliance indicators obtained from the compliance report, wherein the first value of findings and second value of findings are conveyed to at least one of the plurality of application modules for managing and processing one or more workers' compensation cases.

Additional features and benefits of the exemplary embodiments of the present disclosure will become apparent from the detailed description, figures and claims set forth below.

### BRIEF DESCRIPTION OF THE DRAWINGS

The present disclosure will be more clearly understood from the following detailed description of the embodiments of the disclosure and from the attached drawings, in which:

FIG. 1 shows a block diagram of a comprehensive case management system (CCMS) operating under a single platform and accessible via an open portal for coordinating and managing injury cases between multitudes of parties, according to an embodiment.

FIG. 2 shows a worker's compensation claim flowchart in the Employee's Module of the CCMS, according to an embodiment.

FIG. 3 shows a framework of actionable options generated by the Employee's Module and presented to the employee, according to an embodiment.

FIG. 4 shows another framework of actionable options generated by the Employee's Module and presented to the employee, according to an embodiment.

FIG. 5 shows a framework of the settlement alerts option shown in FIG. 4, according to an embodiment.

FIG. 6 shows a framework of the benefit status under the settlement alerts option shown in FIG. 5, according to an embodiment.

FIG. 7 shows another framework of the benefit status 10-21a under the settlement alerts option shown in FIG. 5, according to an embodiment.

FIG. 8 shows a framework of the settlement offer pending under the settlement alerts option shown in FIG. 5, according to an embodiment.

FIG. 9 shows a framework of the communication alert option shown in FIG. 4, according to an embodiment.

FIG. 10 shows a framework of the “My Attorney” option under the communication alert option shown in FIG. 9, according to an embodiment.

FIG. 11 shows a framework of the find an attorney option under the “my attorney” option shown in FIG. 10, according to an embodiment.

FIG. 12 shows a framework of actionable options generated by the Employer's Module and presented to a representative of the employer such as a direct supervisor, risk manager, or human resource personnel, according to an embodiment.

FIG. 13 shows a framework of Workers' Compensation (“WC”) claim options generated by the Employer's Module and presented to the employer, according to an embodiment.

FIG. 14 shows a framework of actionable options generated by the Employer's Module and presented to the employer after the WC claim is initiated or updated, according to an embodiment.

FIG. 15 shows a framework of actionable options generated by the Physician's Module and presented to a physician assigned to the WC claim, according to an embodiment.

FIG. 16 shows a framework of actionable options generated by the Attorney's Module and presented to the defense attorney and applicant's attorney who is assigned to the WC claim, according to an embodiment.

FIG. 17 shows a framework of additional actionable options generated by the Attorney's Module and presented to the defense attorney DA for handling WC claims, according to an embodiment.

FIG. 18 shows a framework of the medical option generated by the Attorney's Module and presented to the defense attorney DA for handling WC claims, according to an embodiment.

FIG. 19 shows a framework of the proposed letters and exhibits option of the medical-legal (“med-legal”) component generated by the Attorney's Module and presented to the defense attorney DA for handling WC claims, according to an embodiment.

FIG. 20 shows a framework of the appointment and scheduling option of the med-legal component generated by the Attorney's Module and presented to the defense attorney DA for handling WC claims, according to an embodiment.

FIG. 21 shows a framework of the reports option of the med-legal component generated by the Attorney's Module and presented to the defense attorney DA for handling WC claims, according to an embodiment.

FIG. 22 shows a framework of actionable options generated by the TPA Module and presented to an adjuster assigned to the WC case, according to an embodiment.

FIG. 23 shows an overview of the AMA compliance detection module that determines claim compliance based on AMA guidelines, according to an embodiment.

FIG. 24 shows a detailed exemplary embodiment of the report generator as shown in FIG. 23.

FIG. 25 shows a detailed exemplary embodiment of the analyzer as shown in FIG. 23.

FIG. 26 shows a detailed exemplary embodiment of valuation logic as shown in FIG. 23.

FIG. 27 shows an exemplary embodiment of a method for operating a report generator to receive medical information and generate an optimized medical report.

FIG. 28 shows an exemplary embodiment of a method for operating an analyzer to receive an optimized medical report and generate a compliance report.

FIG. 29 shows an exemplary embodiment of a method for operating valuation logic to receive a compliance report and generate a value of findings.

FIG. 30 shows an exemplary embodiment of an optimized medical report that illustrates how for each body part, tests are identified and the results of those tests are presented.

FIG. 31 shows an exemplary embodiment of a compliance report that illustrates how for each body part, a compliance value is determined for each test.

FIG. 32 shows an exemplary embodiment of a value of findings report that illustrates how tests for different body parts are grouped by compliance levels.

FIG. 33 shows an overview of a legal compliance detection module of the CCMS for determining claim compliance based on applicable state and government legal codes, according to an embodiment.

FIG. 34 shows an exemplary system architecture hardware systems, networks, and ancillary components under which the CCMS operates and executes programmable instructions and logic to facilitate the handling of WC claims, according to an embodiment.

### DETAILED DESCRIPTION

Aspects of the present disclosure relate to a comprehensive case management system (CCMS) and methods and/or apparatus for determination of claims compliance. In particular, the comprehensive case management system may operate under a single platform having multiple modules which are streamlined to facilitate and integrate the origination, processing and resolution of Workers' Compensation and Personal Injury claims.

The purpose of the following detailed description is to provide an understanding of one or more embodiments of the present disclosure. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming but would nevertheless be a routine undertaking of engineering for those of ordinary skills in the art having the benefit of embodiment(s) of this disclosure.

Various embodiments of the present disclosure illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In various exemplary embodiments, a compliance detection apparatus or module is disclosed that comprises at least one of a CPU, processor, state machine, logic, memory, discrete hardware and/or any combination thereof to perform compliance detection as discussed herein.

CCMS Introduction:

From a high-level operational standpoint, the CCMS may be viewed as an interactive and automated intelligent workflow that aggregates and analyzes data sets obtained from multiple parties in a workforce environment, streamlining communication between the multiple parties, tracking workers' compensation claim data sets, and determining compliance related to workers' compensation claims. In addition, the CCMS may increase access to documentation and create enhanced documentation which the different parties can use to determine claim status or claim deficiencies. In one aspect, the CCMS may be configured to support employees within the workforce environment who currently have no easy or systematic way to access information about their workers' compensation claims and any real-time status related to their case. Furthermore, the CCMS may aggregate, track, and analyze information related to employers of the workforce environment and types of claims that are filed and received by the employer which can be separated by type of business for each employer, for example. Lastly, the CCMS is configured to correlate and analyze the aggregated data sets between the different parties, determining the appropriate course of action for each worker's compensation claim based on a predetermined set of health codes, regulations and statutes or treatises. In one aspect, the aggregated data sets acquired by the CCMS may enhance not only information provided by direct data inputs from users, but can also rank the relevance and compliance of acquired data sets based on relevant law, statutes, regulations, and requirements, transforming such information into a simplistic form so that a layman reading the information could quickly and easily understand how detrimental or not information contained within document is. In another aspect, portions of the CCMS may implement advanced technology such as automated data mining methods and artificial intelligence (AI) in order to collect and analyze the medical-legal reports compared to the AMA Guides. In yet another aspect, the CCMS is configured to ensure regulatory compliance such as HIPAA compliant standards, protecting each party's integrity and privacy and preventing any breach of any communication rules defined therein. In another aspect, the CCMS detects legal compliance with respect to whether certain benefits awarded to an employee are warranted under applicable law.

CCMS Overview and Integration:

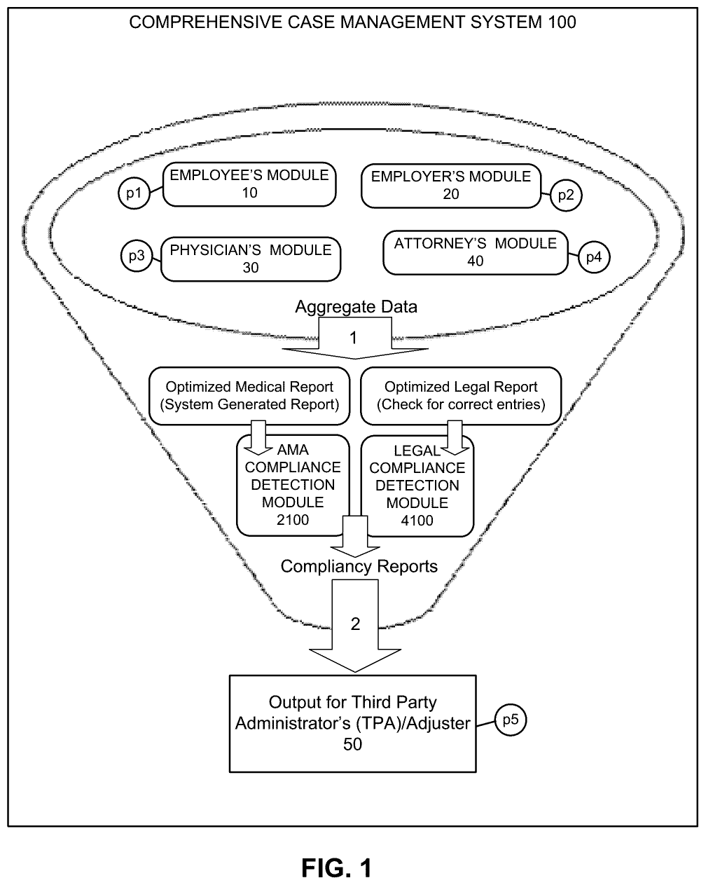

FIG. 1-FIG. 22 illustrate a system level integration of the CCMS 100 by which multiple portals (p1-p5) are presented to respective multiple parties in a workforce networking environment, operating in a unified single platform. In operation, the CCMS can provide multiple parties entry points via portals by which an aggregate of data sets related to workers' compensation claims are received and conveyed. The parties involved in the workforce environment may include but are not limited to 1) Employees, 2) Employers, 3) Third Party Administrators (Adjusters or insurance carriers), 4) Physicians, and 5) Attorneys.

FIG. 1 shows a block diagram of a comprehensive case management system (CCMS) 100 operating under a single platform and accessible via an open portal for coordinating and managing injury cases between multitudes of parties, according to an embodiment. In an exemplary embodiment, each portal (p1-p5) in the CCMS 100 may have its own module for executing commands, displaying instructions to users, and handling worker's compensation claims. In addition, each portal may provide access to the CCMS 100 via a web browser, smart-device application (“app”), or custom local program applications having a network connection to the system. The CCMS 100 can provide many advantages to employees, employers, carriers (adjusters), and other parties, including but not limited to streamlined and smart automation of all worker's compensation procedures, improved communication, more information/more necessary information, quicker access to information, incorporated access to information, enhanced documentation, and compliance information.

In FIG. 1, modules driving each portal (p1-p5) may include but are not limited to an Employee's Module 10 at portal p1, an Employer's Module 20 at portal p2, a Physician's Module 30 at portal p3, an Attorney's Module 40 at portal p4, and a Third Party Administrator's (TPA) Module 50 at portal p5. In addition, the CCMS 100 may include an AMA Compliance Detection Module 2100 for assessing compliancy based on AMA guidelines and a Legal Compliance Detection Module 4100 for assessing compliancy based on a set of state and government legal codes, where both detection modules are configured to assess and qualify workers' compensation claims-related data received at each module. In operation, data from a workers' compensation claim may be collected at each portal (p1-p5) and then subsequently combined into an aggregated data set 1 that is funneled into the Compliance Detection Modules (2100, 4100) for analysis and qualification purposes, resulting in a set of compliancy reports 2 that are transmitted and conveyed to the TPA Module 50. Upon receipt of the set of compliancy reports 2 from the Compliance Detection Modules (2100, 4100), the TPA Module 50 may initiate a notification to the adjuster and provide them compliancy data and suggested compliancy decisions for determining actions including but not limited to benefit termination, and start and benefit calculation.

Employees Module:

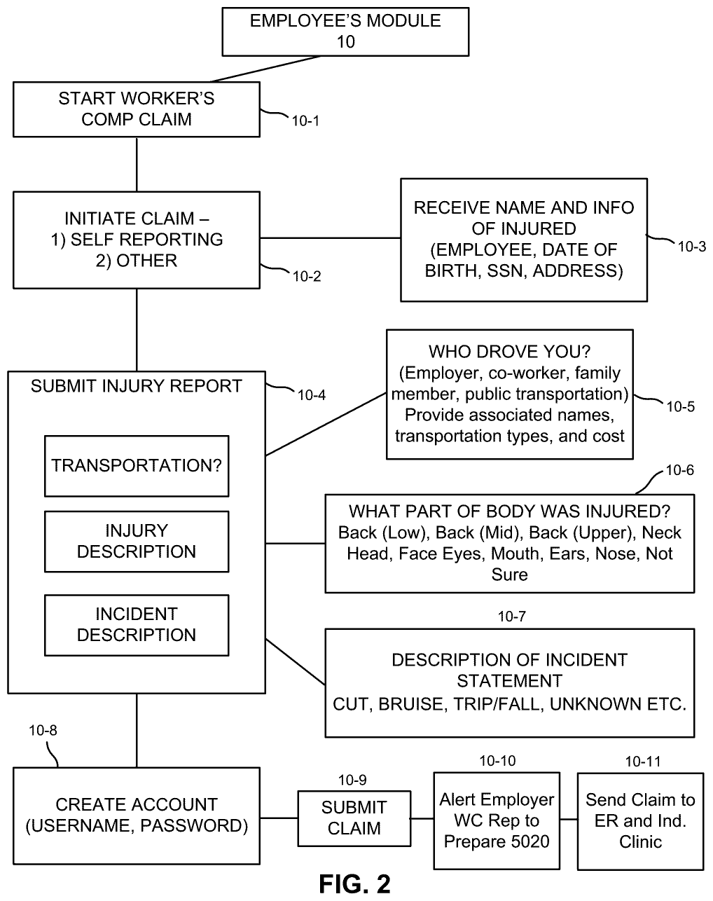

FIG. 2 shows a worker's compensation claim flowchart in the Employee's Module 10 of the CCMS 100, according to an embodiment. Every WC claim begins with an employee reporting an injury or alleging an injury (step 10-1). The WC claim can be reported on the day it occurs or any time thereafter including after termination or retirement. The employee, as defined here, is a qualified individual who was hired by an employer to perform specific duties, functions, and roles within the company, business, or organization. The WC claim may be self-reported by the employee or by another party (step-10-2). Data collected and received at this step may include the name and identification information of the injured person (e.g., employee name, date of birth, SSN, and address) (step 10-3). Thereafter, the Employee's Module 10 generates an injury report inquiry form (step 10-4) which the employee completes and submits to the CCMS 100. The injury report data collection input form may include transportation inquiries (10-5), an injury description (10-6), and an incident description (10-7). Next, the Employee's Module 10 generates and presents an employee's login form 10-8 through which the employee completes and submits to the CCMS 100 in order to create their account. The employee's login will be used not only for their personal log-in but also at any significant event involving their participation. This will help aggregate information on the workers' compensation claim. Once the employee's login form 10-8 is submitted by the employee and subsequently received by the CCMS 100 (step 10-9), a notification alert is generated (step 10-10) by the employees module 10 which automatically sends the alert to the employer's workers' compensation representative to prepare what is called in the field a 5020 form. Finally, the Employee's Module 10 may also prepare and relay the workers' compensation claim to a health care facility such as an emergency room or independent health clinic (step 10-11).

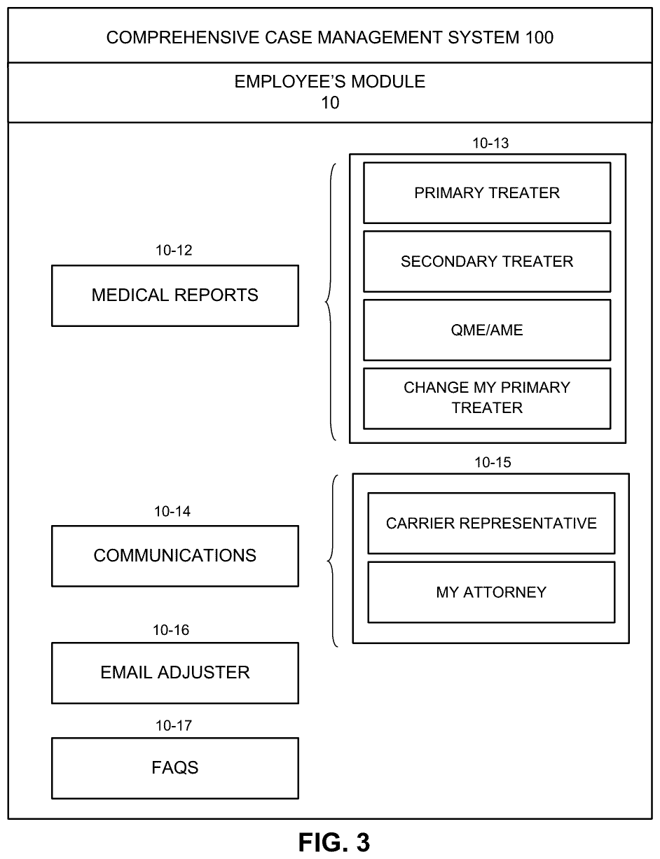

FIG. 3 shows a framework of actionable options generated by the Employee's Module 10 and presented to the employee, according to an embodiment. For example, the actionable options may include 1) a medical reports option 10-12 by which the employee may access, define, or update medical treater information 10-13 (e.g., primary treater, secondary treater, QME/AME); 2) communication notices 10-14 through which information from a carrier representative or attorney are accessible by the employee 10-15; 3) an email adjuster option 10-16 by which emails or digital communication between an adjuster are handled; and 4) Frequently Asked Questions option (FAQs) 10-17 which provides the employee a list of answers to specific questions related to the processing of WC claims.

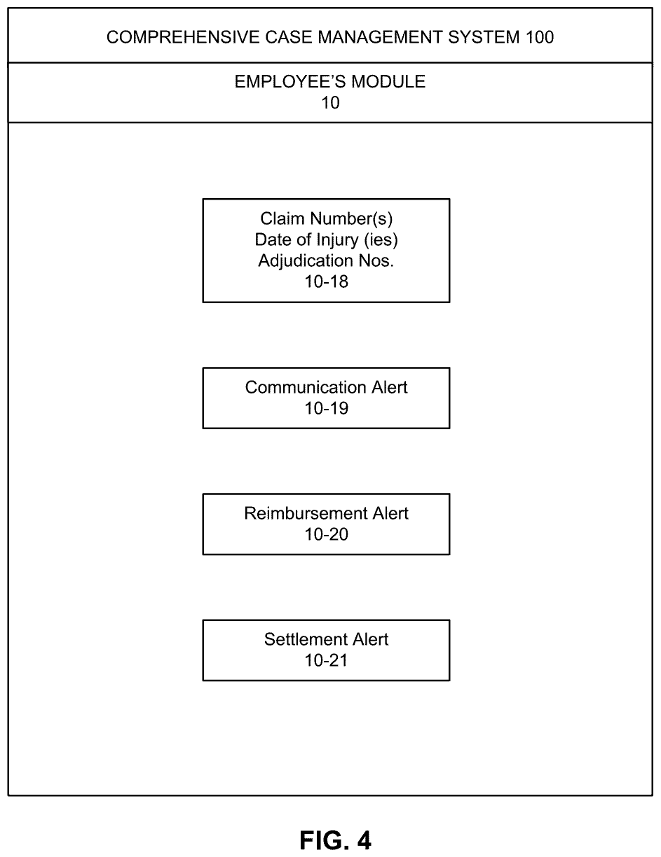

FIG. 4 shows another framework of actionable options generated by the Employee's Module 10 and presented to the employee, according to an embodiment. For example, the second framework of employee actionable options may include a list of WC claim numbers 10-18, communication alert option 10-19, reimbursement alert option 10-20, and settlement alert option 10-21 from which the employee may choose. In operation, these options may provide an input means for collecting and receiving employee documentation that is required by law in order to handle, process, and determine decisions of WC claims submitted via the Employee's Module 10.

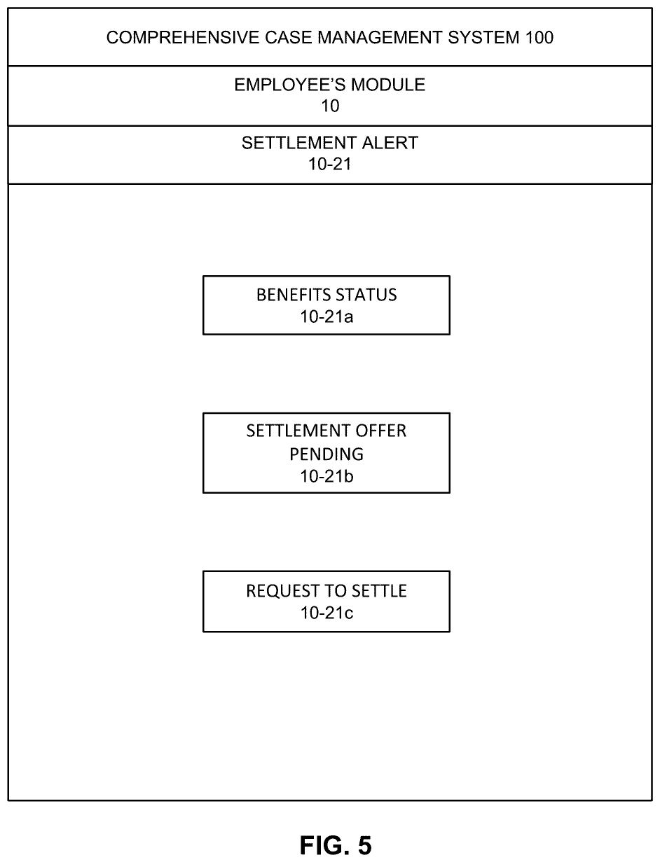

FIG. 5 shows a framework of the settlement alerts option 10-21 shown in FIG. 4, according to an embodiment. The settlement alerts option 10-21 provides the employee additional operations for handling benefit status 10-21a, status of pending settlement offers 10-21b, and making requests to settle a WC claim 10-21c.

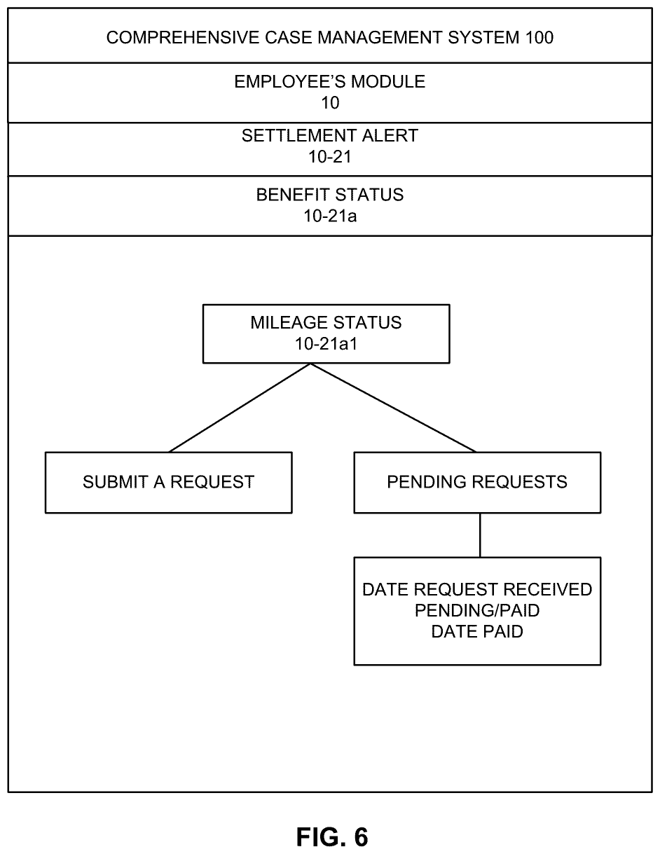

FIG. 6 shows a framework of the benefit status 10-21a under the settlement alerts option 10-21 shown in FIG. 5, according to an embodiment. The benefit status 10-21a provides the employee additional functions, allowing them to submit and check requests related to mileage status 10-21a1 and reimbursement payment thereof. In operation, the CCMS 100 can effectively and efficiently handle these requests submitted by the employee such that the payment to the employee is issued faster in comparison to paper submissions. In addition, an instant notice can be triggered by the Employee's Module 10 for any invalid requests, notifying the employee, via digital communication, of errors made in any of their request submissions. In addition, the CCMS 100 can determine anticipated mileage information driven by the employee to any physicians that are registered and have profiles available in the system, determining the total distance, and then automatically calculating an anticipated reimbursement payment to the employee. If payment is not received in a timely manner, the system 100 provides a means through which the employee may follow up via the communication alert option 10-19.

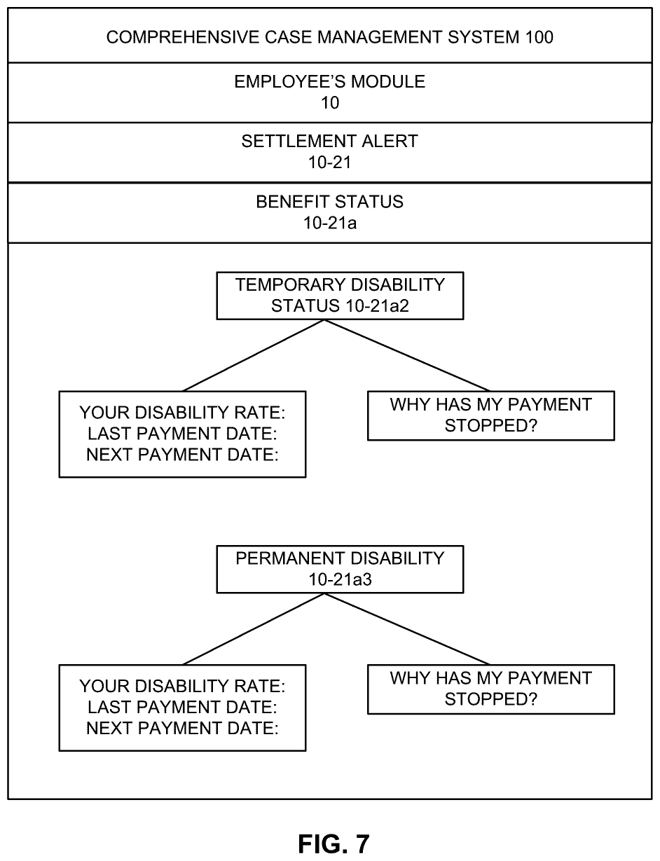

FIG. 7 shows another framework of the benefit status 10-21a under the settlement alerts option 10-21 shown in FIG. 5, according to an embodiment. In addition to the previous embodiment, the benefit status 10-21a may provide other function to the employee, including status information for temporary disability 10-21a2 and permanent disability 10-21a3, and allowing the employee to acquire disability rates and payment dates. In addition, the benefit status 10-21a may also provide the employee an option to acquire and access real-time information from the system 100 relating to stopped payment benefits, allowing them to submit follow up questions via the communication alert option 10-19.

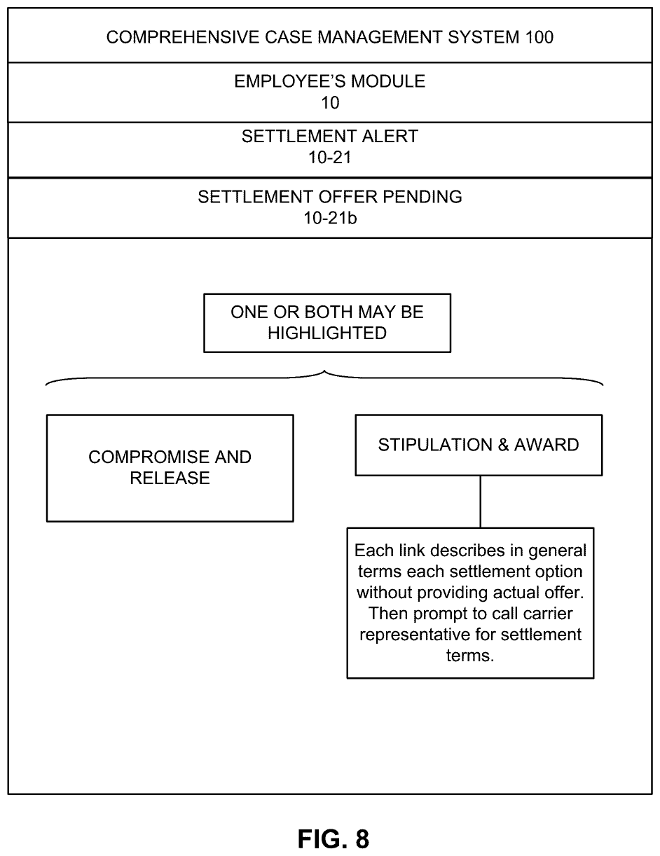

FIG. 8 shows a framework of the settlement offer pending 10-21b under the settlement alerts option 10-21 shown in FIG. 5, according to an embodiment. In this framework of the settlement offer pending 10-21b, the Employee's Module 10 may generate and present the employee two types of pending offers: 1) compromise and release; and 2) stipulation and award. One or both of the pending offers may be highlighted depending on the offer pending status per WC claim. In the stipulation and award, a link may be generated and provided to the employee describing general terms of each settlement option without providing an actual offer. In addition, CCMS 100 may take further actions, including initiating a prompt to call the carrier/adjuster representative for settlement terms.

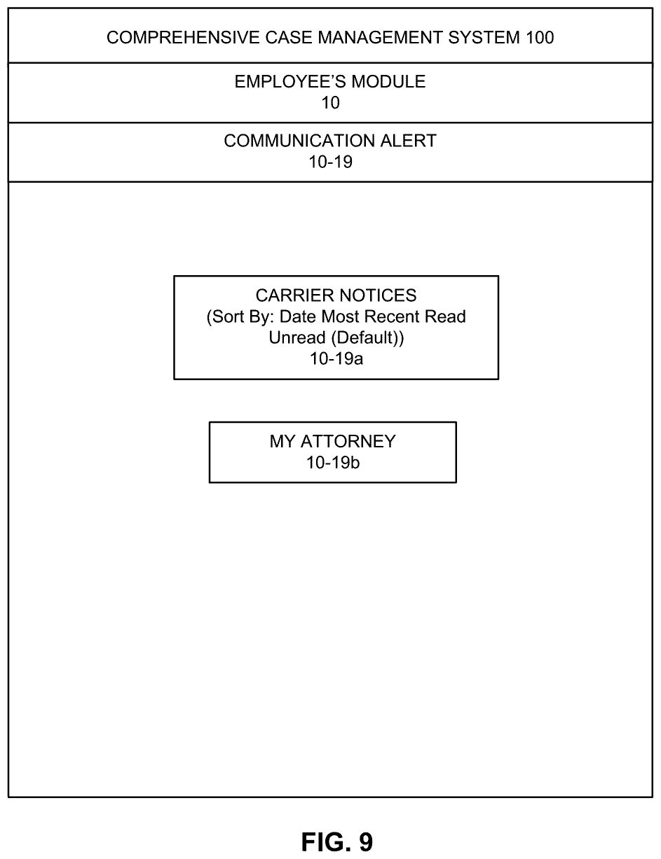

FIG. 9 shows a framework of the communication alert option 10-19 shown in FIG. 4, according to an embodiment. In one implementation, the communication alert option 10-19 may include communication functions allowing the employee to directly access and read carrier alerts, notices, and messages 10-19a and access and initiate attorney communication via a “My Attorney” option 10-19b.

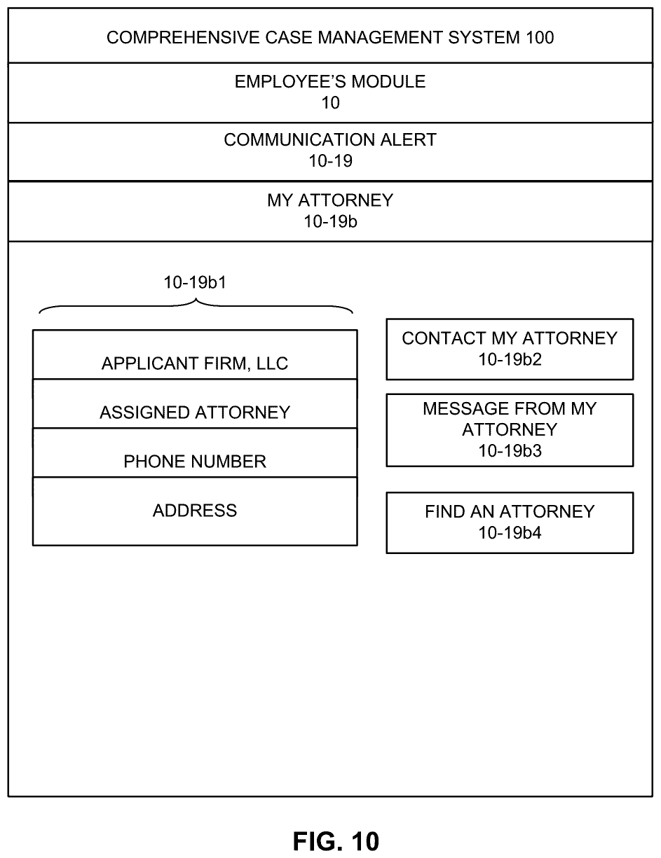

FIG. 10 shows a framework of the “My Attorney” option 10-19b under the communication alert option 10-19 shown in FIG. 9, according to an embodiment. In this framework, the Employee's Module 10 may populate and present an assigned attorney representing the WC claim to the employee along with the attorney's contact information 10-19b1. The Employee's Module 10-1 may also populate and present to the employee additional options which allow them to contact their assigned attorney 10-19b2, obtain messages from their assigned attorney 10-19b3, and locate other attorneys 10-19b4 should they wish to seek counsel and advice from other legal professionals.

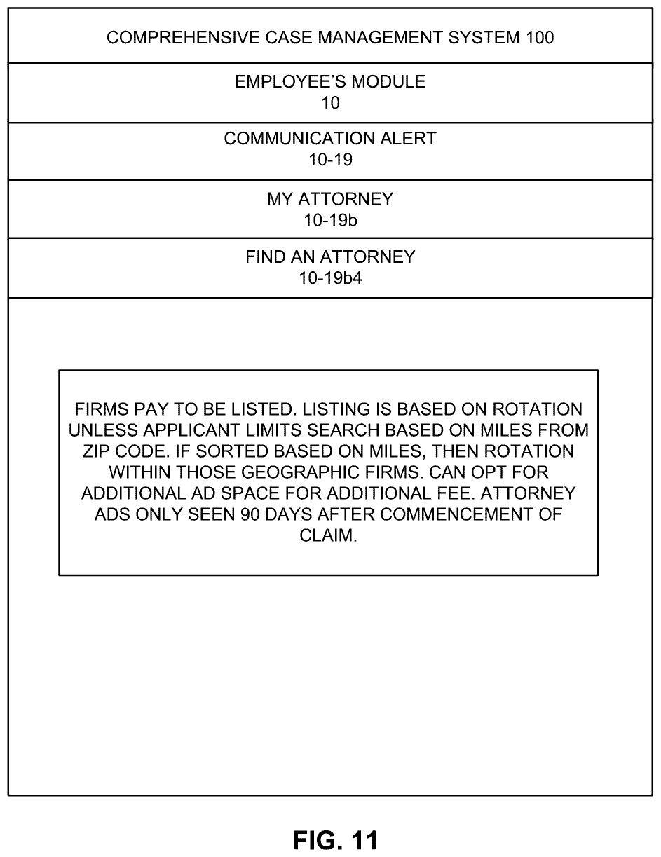

FIG. 11 shows a framework of the find an attorney option 10-19b4 under the “my attorney” option 10-19b shown in FIG. 10, according to an embodiment. While the system 100 should reduce litigation by increasing comprehension at an employee level, if an employee does not have an attorney and still wants one, the Employee's Module 10 provides an option for them to search for local attorneys. In this framework, the Employee's Module 10 may populate and present to the employee a listing of qualified attorneys for handling their WC claim. In one aspect, a law firm may pay to have an advertisement listed in this section based on requirements set forth by the system 100. The attorney ad listings may be displayed in accordance with a predetermined ad rotation of attorneys available in the system 100, unless the employee limits the search requirements based on a distance from a given zip code. In another aspect, the attorneys listed are compliant with state bar requirements for legal referral services, and will require a fee from the attorney firm to participate.

In regards to the Employee's Module 10, the CCMS 100 may provide a portal p1 through which the employee may create a user account or log into the CCMS 100. In another instance, all information related to WC claims and collected by the CCMS 100 may be auto-populated by the system. In yet another instance, employers may register their employees on the date of hire so that the employees can locate their own customized portal once they begin their first day of employment. Before initiating a WC claim in the CCMS 100, the employee is required to create and submit a profile including their name, contact information, and other relevant information or information of interest that will be used for the WC claim.

All data received through the Employee's Module 10, including but not limited to employee profile data, WC claim data, communication data, and all information data are stored in a CCMS central database that is accessible by other modules as warranted in the CCMS 100. Employees may have limited access to certain files depending on security level access, authorization assigned to them by their employer or the system 100, or other factors, including attorney discretion or the need to prevent mismanagement of information stored in the CCMS central database.

In one advantage, the Employee's Module 10 can provide an easy way for the employee to communicate with their doctor, their attorney, and their adjuster. For example, when an employee visits their primary doctor (treater) for their regular 30-day physical exam appointment, they are generally required to check-in at the physician's office and will be asked a few health-related questions regarding a change in their condition. Answers to these questions may be auto-populated by the system 100 into a physician's report that is issued as part of that exam. Subsequently, the doctor may access the Physician's Module 30 in the CCMS 100, filling in the remaining health data from the physical exam into the system 100.

In another advantage, the Employee's Module 10 can provide employees an active role in resolving their claims informally—by not only making it very clear to them that resolution is an option, but by presenting opportunities for them to reach out to adjusters about their settlement to a claim or vice versa, allowing the adjuster to contact the employee directly about their claim.

Employers Module:

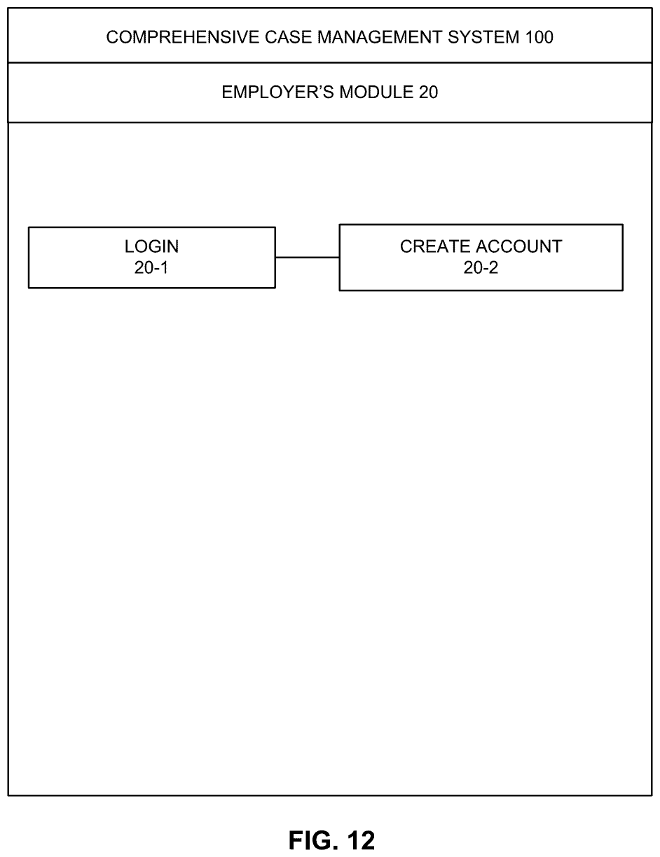

FIG. 12 shows a framework of actionable options generated by the Employer's Module 20 and presented to a representative of the employer such as a direct supervisor, risk manager, or human resource personnel, according to an embodiment. Prior to utilizing the CCMS 100, employers may register and sign-up on their own or through a built-in incentive through their insurance company or TPA. To facilitate employer sign-ups, actionable options for registering employers may include a login 20-1 and create account 20-2 options allowing the employer to access and manage WC claims in the CCMS 100. In one aspect, the CCMS 100 may require every employer to have an active and updated profile in order to maintain their account, created one-time and updated at any time. For example, this profile information may include the name of the point-of-contact for workers' compensation claims reporting and a list of job duties for all positions. In one instance, the profile information can be used to automatically correlate WC claims and also populate information in the Employee's Module 10 when a profile is created by an employee. In another instance, the profile information may allow the employer to register their preferred occupational clinic into the CCMS 100 and create a reporting tie between itself and that medical facility for the initial screening evaluation. In yet another instance, whenever an employee is hired, their profile information including their name, date of birth, and social security number may be added into the CCMS central database which is accessible by the Employer's Module 20 for easier or more streamlined processing of WC claims.

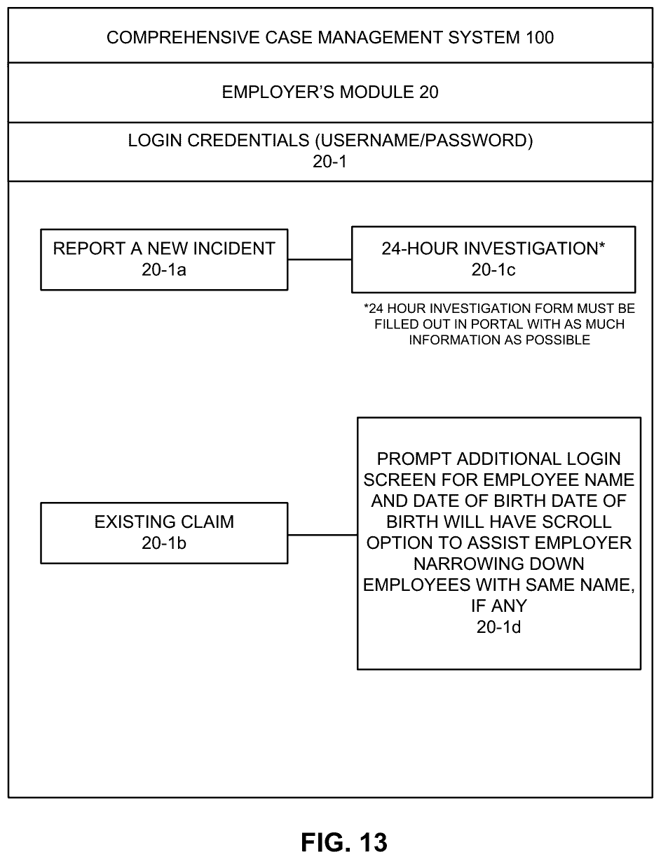

FIG. 13 shows a framework of WC claim options generated by the Employer's Module 20 and presented to the employer, according to an embodiment. The WC claim options in this framework may allow the employer to: 1) Report a New WC Claim Incident 20-1a; and 2) Access and/or update an existing WC claim 20-1b. For new claim incidents, the system 100 may require a 24-hour investigation 20-1c, prompting the employer to complete and submit an investigation form in the Employer's Module 20. For the existing WC claims, the system 100 may assist the employer in locating a claim based on employee name and date of birth, allowing the employer to narrow the field of search of employees having the same name 20-1d.

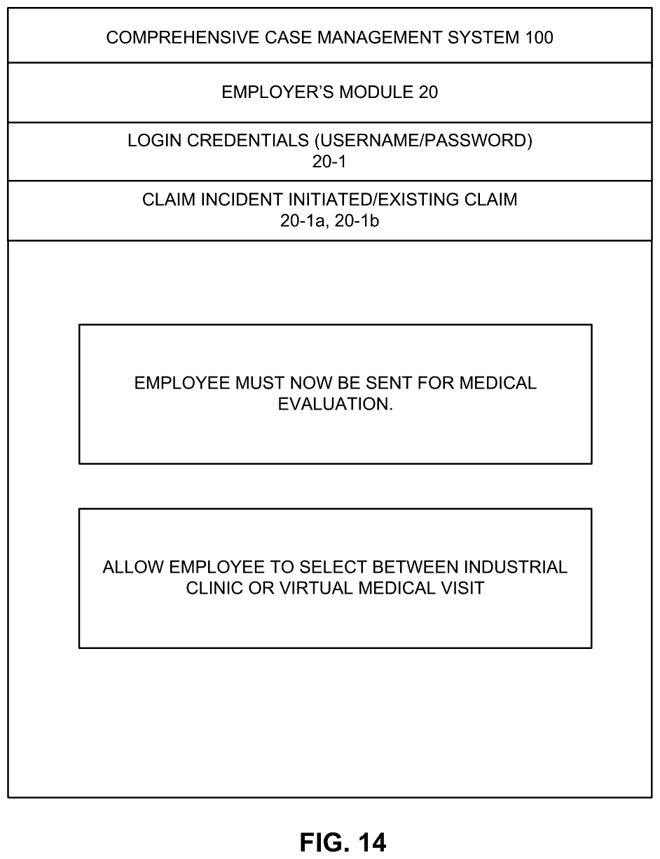

FIG. 14 shows a framework of actionable options generated by the Employer's Module 20 and presented to the employer after the WC claim is initiated or updated, according to an embodiment. In this framework, the employer is prompted by the system 100 with additional actions related to the WC claim. For example, the system may prompt the employer to 1) send the employee for medical evaluation; and 2) allow the employee to select between industrial clinic or virtual medical visit.

In operation, when a WC claim is initiated by the employee in the Employee's Module 10, the system 100 may generate a notification or alert to the employer via the Employer's Module 20. When the employer (e.g., supervisor or manager) receives the notification of the alleged WC claim, the Employer's Module 20 may generate and provide the employer a list of the alleged WC claims, allowing them to select the employee reporting the claim. The Employer's Module 20 may prompt the employer with basic questions to ensure a catastrophic injury is not involved. For catastrophic injury cases, the Employer's Module 20 may generate and prompt the employer with a different set of protocols and reports, including an Occupational Safety and Health Administration (“OSHA”) report, for example.

Overall, the basic flow and process in a reported WC claim may include: 1) an employee reports an alleged incident (WC claim) in Employee's Module 10; 2) the employer logs all basic information related to the alleged incident into the system 100 via the Employer's Module 20; 3) the system 100 populates the information into an incident report which is then transmitted in real-time to an occupational/medical clinic selected by the employer; 4) the employee is then required to go to the occupational/medical clinic for a physical evaluation and assessment; 5) simultaneously, the system 100 will trigger an alert at the employer's HR/Risk Manager level so that the next appropriate steps regarding reporting and paperwork can be timely and properly met; 6) the system 100 generates employer level investigation documents which are intended to collect information on the employee; 7) the system 100 may correlate this incident with the employee data provided in the Employee's Module 10; 8) the system 100 provides the employer access to information throughout the WC claim; and 9) the system 100 generates timely reports of work restrictions so that offers of work can be made immediately and without delay to the employee.

Physician's Module:

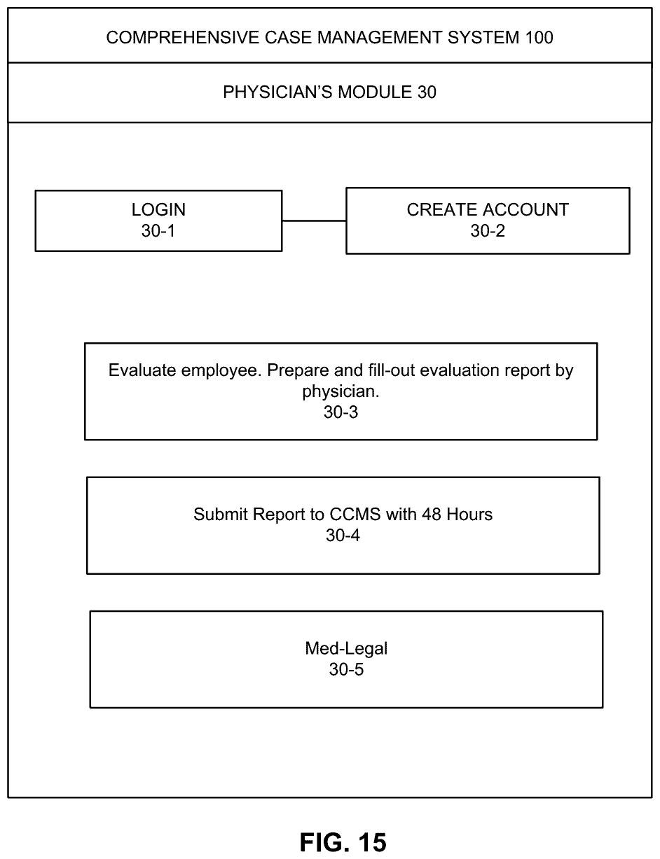

FIG. 15 shows a framework of actionable options generated by the Physician's Module 30 and presented to a physician assigned to the WC claim, according to an embodiment. The Physician's Module 30 may include a login option 30-1 and a Create Account option 30-2 allowing a preconfigured login access and sign-up registration for a Primary Treater Physician (PTP), a Secondary Treating Physician (STP), or a Med-Legal Evaluator (Qualified Medical Evaluator, QME, or Agreed Medical Evaluator, AME).

The Physician's Module 30 may receive health-related information from the employee including updated information related to their health condition. Once this information is received by the Physician's Module 30, the PTP may perform a physical examination to evaluate the employee's current condition 30-3. In addition, the Physician's Module 30 may generate a predetermined health selection form containing clickable health fields and boxes that the PTP can easily complete via an appropriate and applicable selection of check boxes. The health input selection elicited in the Physician's Module 30 from the PTP is made to be efficient and organized, providing a more logical flow and order than that found in the current traditional state mandated forms. Advantageously, the Physician's Module 30 may provide the PTP an efficient tool that the PTP can use to easily and efficiently prepare documentation for which they are ultimately paid. This can be a revenue generation benefit for the PTP because the TPA is incentivized to pay the PTP more since the additional health information provided to the system 100 by the PTP may help WC claim cases significantly, reducing overall costs, and thereby passing some of that cost savings to the PTP.

In some instances, WC claims may be denied to an employee, yet the employee may still receive treatment by the PTP via a ‘lien basis’ program. In another embodiment, the CCMS 100 can support innovative incentives for ‘lien basis’ programs and PTP doctors treating employees under this program, encouraging the PTPs to work and use the CCMS 100. In particular, the benefit to TPA and employer is ultimately cost savings and increased collection of employee health information related to the WC claim.

After each employee physical evaluation, the PTP will generally have about 48 hours (30-4) to complete and submit the evaluation report to the CCMS central database via data upload. Thereafter, the CCMS 100 may process and validate the report, generating a work status report that is made available to the employee, employer, and adjuster via the Employee's Module 10, Employer's Module 20, and TPA Module 50, respectively. The enhanced aggregation of health information received by the system 100 is configured to move the WC claim forward in an organic way by pushing the doctor to assess—at certain intervals—important and necessary physical screening and evaluations that are often lost for years during the pendency of treatment. Advantageously, the system 100 can ensure that necessary and important evaluations are performed and addressed, encouraging the PTPs throughout the WC claim process to provide the medical care in order to treat employees and thereby reducing their time off from work. It should be noted that the Secondary Treating Physicians (STPs) operate similarly to PTPs in terms of report generation and submissions to the CCMS 100.

The Physician's Module 30 may also include a Med-Legal option (30-5), which historically has operated in a complicated manner. First, the Physician's Module 30b provides for certain communication and documentation sharing that will be available to Med-Legal only after both parties (i.e., attorneys and unrepresented applicant/TPA) agree to their disclosure. Once that agreement is made, the CCMS 100 can determine and automatically release documents from the parties to Med-Legal for Med-Legal review as part of an examination or supplemental report.

The Med-Legal report can ultimately be integrated into the CCMS 100 to facilitate completion of an employee's injury evaluation. Ideally, there will be a standardized medical report for processing the Med-Legal option. In one aspect, a Qualified Medical Evaluator (QME) (a medical provider who provides a medical-legal assessment of an injured employee, typically after a PTP or STP) may input in the CCMS 100 specific findings and measurements from the physical examination of the employee. The measurements and findings may be correlated or compared to pre-populated information received and stored in the central database by the system 100 via the AMA Guides. In addition, these findings and measurements can also allow the QME to upload their report into the system 100 for distribution to the parties via appropriate modules. Furthermore, one objective of the CCMS 100 is standardizing the input measurements received by various parties and then generating an optimized report as a final output which a non-physician non-expert can understand.

In another implementation, the CCMS 100 may utilize a rating and ranking program configured to analyze the findings of the QME and rank the compliance of those findings to the AMA Guides such that the TPA can assess and determine the next appropriate action to take during the WC claim process, reducing unnecessary compliance decision delays by automating and streamlining the overall claim process. In addition, the QME report will be automatically accessible to the PTP/STP as well for evaluation and feedback purposes.

Attorneys Module:

The purpose of the Attorney's Module 40 is to allow attorneys the ability to interact directly and succinctly with their respective parties as well as to allow them the ability to interact with the other parties inside of the CCMS 100 platform. The Attorney's Module 40 is configured to allow access and support to both a Defense Attorney (DA) and an Applicant's Attorney (AA).

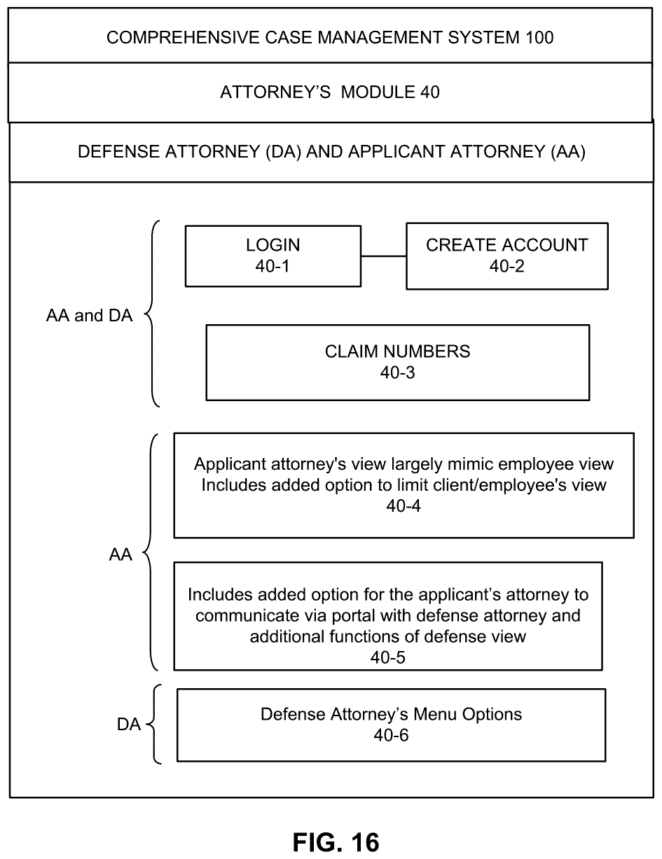

FIG. 16 shows a framework of actionable options generated by the Attorney's Module 40 and presented to the defense attorney and applicant's attorney who is assigned to the WC claim, according to an embodiment. As in the previous modules, the Attorney's Module 40 may include a login option 40-1 and a Create Account option 40-2 allowing a preconfigured login access and a sign-up registration for the Defense Attorney (DA) and an Applicant's Attorney (AA).

In one configuration, the framework of actionable options in the Attorney's Module 40 may also include access to a listing of related WC claims via a claim numbers option 40-3. In addition, actionable options in the Attorney's Module 40 may be configured specifically for the type of attorney accessing the system (i.e., DA or AA). For example, the Attorney's Module 40 may present an actionable option 40-4 by which the applicant attorney may view and access information that largely mimics the employee view in the Employee's Module 10. Moreover, the system 100 may include an option to limit the applicant's attorney from accessing and viewing selected data sets in the Employee's Module 10.

In another aspect, the Attorney's Module 40 may be configured to perform other WC related functions in the system 100. For example, the Attorney's Module 40 may present an actionable option 40-5 to the applicant's attorney by which the AA may communicate via text messages, emails, or video with the defense attorney through the Attorney's Module 40. In yet another aspect, the Attorney's Module 40 may provide the DA access to additional WC claim options configured specifically for the DA (40-6).

In operation, the Attorney's Module 40 provides a means by which the applicant's attorney can limit permission and access of their client's (i.e., the employee), preventing them from viewing certain confidential or restricted documents. In addition, if the AA limits their client's view of what their client can see, it will notify their client via the Employee's Module 10 or by other communication means (e.g., email, text, or video messaging).

In operation, the CCMS 100 can provide the AA the ability to not only manage its case inside of the system, but also communicate with opposing DA. In addition, the CCMS 100 is configured to support a hybrid-paperless system, allowing AA's to participate in an electronic environment via e-documents/e-services without transitioning their entire paper system into a paperless system. This hybrid-paperless system is advantageous to some AA's who have not transitioned over into a paperless system because it may be cost prohibitive. In practice, many AA's largely operate on paper files making it more difficult for them to participate and take advantage of changes in the law such as e-service. Advantageously, the CCMS 100 can support and facilitate both paper and paperless transactions that benefit AA's who lack the electronic infrastructure, saving them from having to spend hundreds of thousands of dollars to transition to the paperless system.

In another advantage, the CCMS 100 can provide a one-stop-shop service to the AA for handling WC cases, giving them direct access to notices on a file they represent without relying on irregular services by their client or by opposing counsel. This should eliminate confusion and the need for unnecessary hearings on discovery issues and also reduce inefficiencies and unnecessary work by the opposing parties.

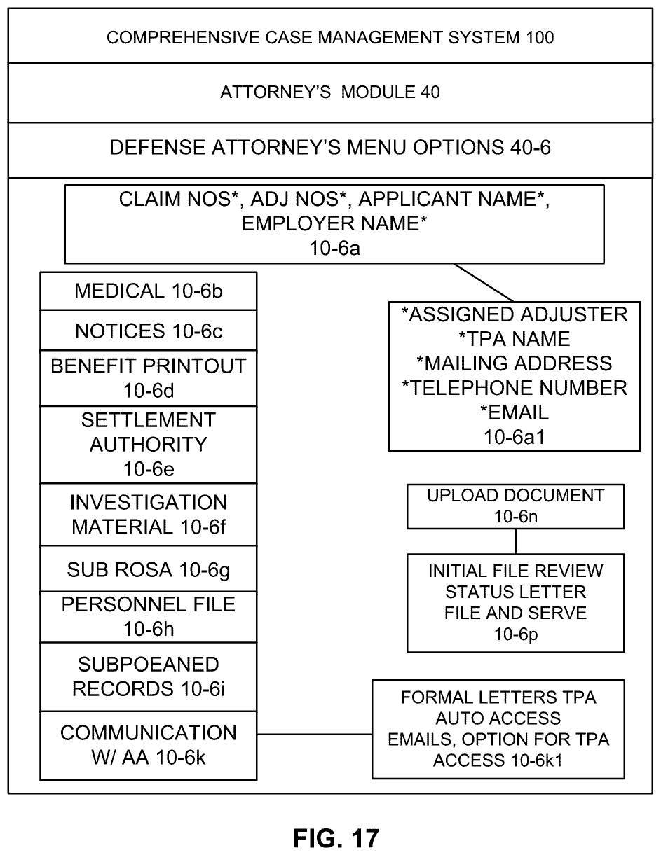

FIG. 17 shows a framework of additional actionable options 40-6 generated by the Attorney's Module 40 and presented to the defense attorney DA for handling WC claims, according to an embodiment. These additional actionable options 40-6 may include several functions which allow the DA to access pertinent WC claim information including but not limited to WC case profile 10-6a, a medical option 10-6b, notices 10-6c, benefit printout 10-6d, settlement authority 10-6e, investigative material 10-6f, Sub Rosa information 10-6g, personnel file 10-6h, and subpoenaed records 10-6i. In particular, the WC case profile 10-6a may include access to the WC claim including claim numbers, adjuster's numbers, applicant's name, and employer's name. In addition, the Attorney's Module 40 may provide the DA access to contact information of corresponding adjusters 10-6a1 for each claim provided in the WC case profile 10-6a. Communication between the AA and DA may be handled via a communications link 10-6k allowing the DA to create messages and access formal letters, emails, and an option for TPA access and TPA auto access 10-6k1. TPA auto access allows the communications link 10-6k1 to auto-sync with the TPA's separate claims system (a system outside the CCMS), in order to streamline communications between the DA and TPA. Additional functions provided within the Attorney's Module 40 include an upload document function 10-6n through which the DA may upload and securely store case related documents to the central CCMS database. These case related documents uploaded by the DA to the system may include, for example, an initial file review, status letters, and file and serve documents function 10-6p with an optional time-stamp feature.

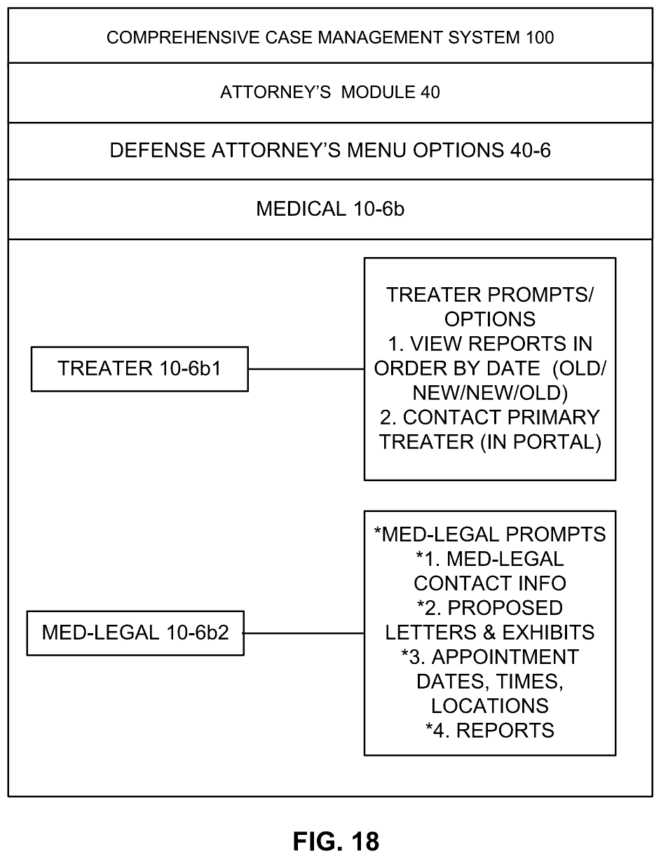

FIG. 18 shows a framework of the medical option 10-6b generated by the Attorney's Module 40 and presented to the defense attorney DA for handling WC claims, according to an embodiment. The medical option 10-6b may include a treater field 10-6b1 by which the DA may access prompts and other options related to uploaded or generated reports and contact information of the PTP, STP, or medical evaluator who is responsible for handling the WC case, and a med-legal field 10-6b2 by which the DA may access med-legal prompts including but not limited to 1) med-legal contact information, 2) proposed letters and exhibits, 3) appointment and scheduling, and 4) uploaded or generated medical reports.

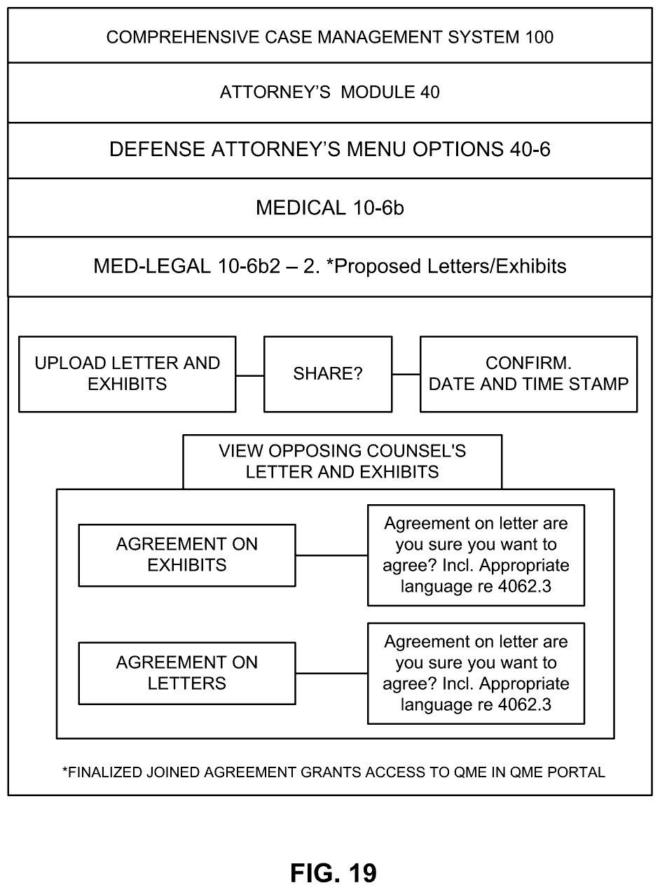

FIG. 19 shows a framework of the proposed letters and exhibits option (#2) of the med-legal 10-6b2 generated by the Attorney's Module 40 and presented to the defense attorney DA for handling WC claims, according to an embodiment. In one aspect, the proposed letters and exhibits option (#2) may include an upload function by which the DA may upload records and/or share letters and exhibits to other parties involved in the WC case (e.g., AA/opposing counsel, or employee). In another aspect, the proposed letters and exhibits option (#2) may also include a view option by which the DA may view opposing counsel's letters and exhibits.

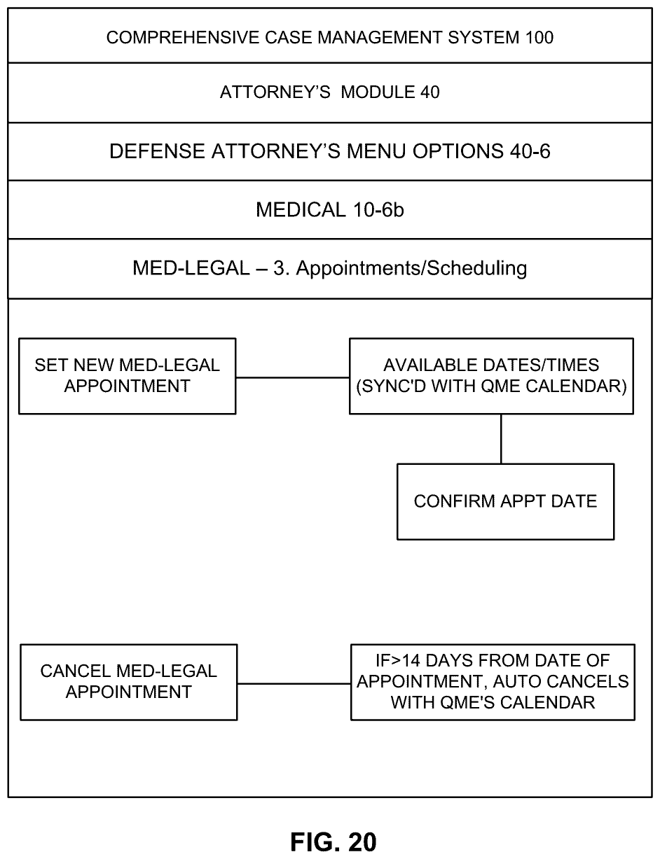

FIG. 20 shows a framework of the appointment and scheduling option (#3) of the med-legal function 10-6b2 generated by the Attorney's Module 40 and presented to the defense attorney DA for handling WC claims, according to an embodiment. In the appointment and scheduling option (#3), the DA may either create new med-legal appointments or cancel existing appointments directly in the system 100. This option may also include an auto-cancellation feature which automatically cancels any scheduled appointments with QME'S calendar that are greater than 14 days from the date of appointment.

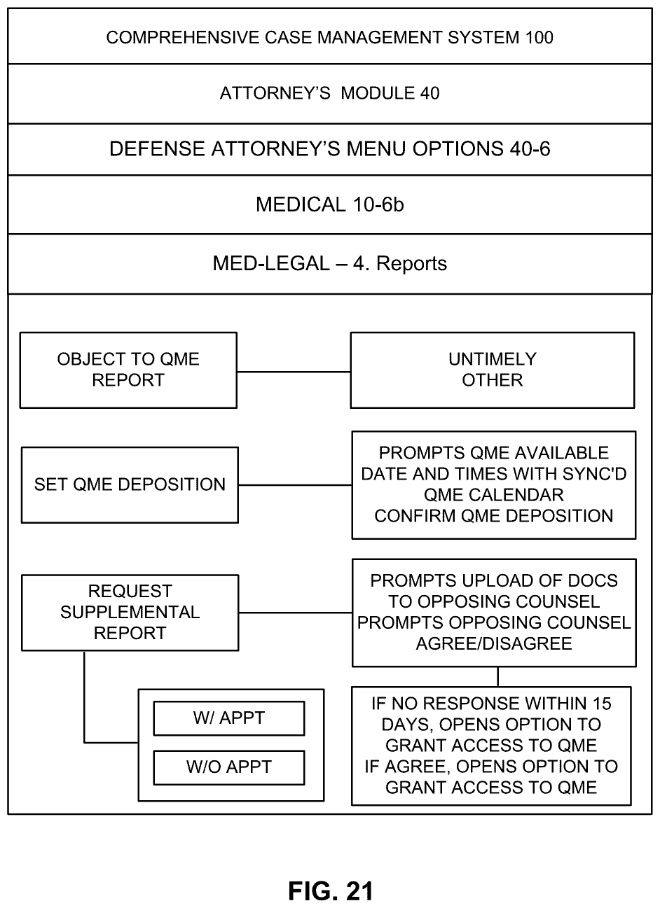

FIG. 21 shows a framework of the reports option (#4) of the med-legal function 10-6b2 generated by the Attorney's Module 40 and presented to the defense attorney DA for handling WC claims, according to an embodiment. In the reports option (#4), Attorney's Module 40 provides the DA a means to 1) object to QME reports, 2) set QME dispositions, and 3) request supplemental reports with and without appointment. When setting a QME deposition, the Attorney's Module 40 may generate and transmit prompts to the QME to schedule and confirm dates for a QME deposition via a synchronized calendar accessible by the DA and QME. When requesting a supplemental report, the Attorney's Module 40 may generate and transmit prompts to the opposing counsel for document uploads and agreements/disagreements decisions. In addition, if no response from the opposing counsel is received within 15 days, the Attorney's Module 40 may generate a permissions option granting access to the QME if agreed.

In sum, the CCMS 100 can provide the defense attorney a platform for handling WC cases with their own client. Today, most defense firms communicate with their clients by email and have little to no access to their clients' internal system. A DA's understanding of the status of a WC case can often rely heavily on the client's ability to relay accurate information, refer documents over and timely serve them such that an analysis can be done. Advantageously, the CCMS 100 can provide a unified platform through which the DA has access to documents pertinent to their representation, almost as if they were part of the TPA's internal case management program. In addition, the CCMS 100 provides a streamlined method by which the TPA can serve requested documents such that the DA can have almost instant access to them. In another advantage, the CCMS 100 is configured to expedite the processing of WC cases by cutting out the ‘middleman’ (i.e. the process of the DA asking for a document, receiving it via email, and then downloading it into their own internal system for review and billing). In particular, the CCMS 100 provides a unified platform where documents are stored and searchable, allowing the DA to request and upload documents into the system easily and instantly. Furthermore, since the documents reside within the unified platform (i.e., central CCMS database), it eliminates the need for the document to ever be moved into separate case management systems.

Another advantage of the CCMS 100 includes real-time communication and notifications, allowing immediate access to WC case related documents and keeping the DA (and other parties) in the loop with regards to various decisions being made related to benefits in WC claims. As a result, decisions from the DA are made contemporaneously rather than days or weeks it can take for existing systems.

With various unique prompts generated by the CCMS 100, the DA is guided via system generated inquiries to make a recommendation to the client on the status of benefits at 45-day intervals. These prompts are intended to bolster or possibly completely supplant the status report such that the DA will be required to make a recommendation based on their professional opinion, as well as also providing an explanation for it. Overall, the system 100 is configured to generate these prompt options for the basis of the recommendation based on the legally understood grounds for such a recommendation.

Third Party Administrator (TPA) Module:

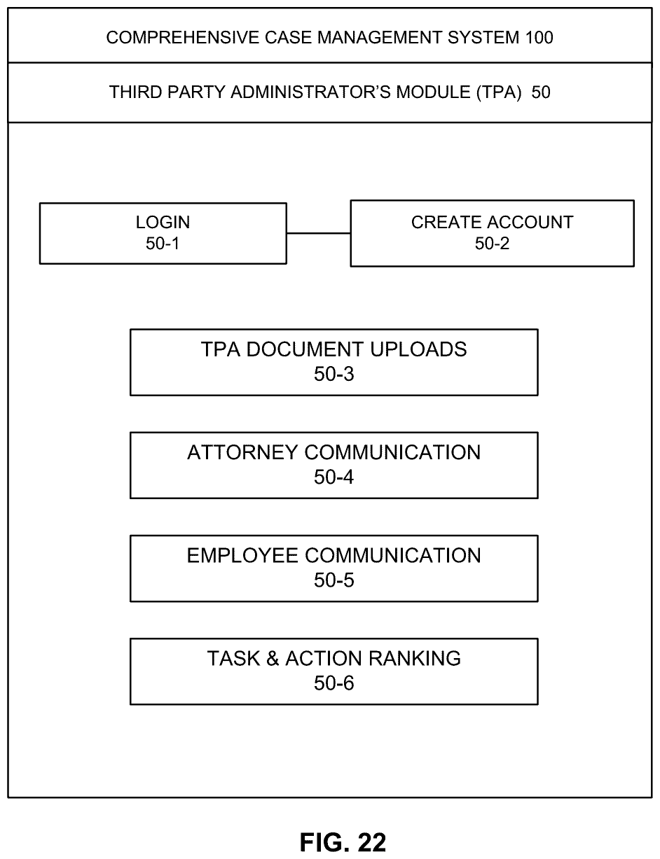

FIG. 22 shows a framework of actionable options generated by the TPA Module 50 and presented to an adjuster assigned to the WC case, according to an embodiment. The TPA Module 50 is configured to facilitate service of required notices with all parties related to the WC claim initiated by or originating from an employee. As part of the CCMS 100 registration and sign-up, adjusters who intend to access and use services offered by the system are required to sign a waiver and other agreements prior to receiving service. For example, a login option 50-1 and a create account option 50-2 are generated by the TPA Module 50 which provides the adjuster options to either access the system using their username and password or generate a new account via the registration and sign-up process.

The TPA Module 50 may also include and offer other options to the adjuster for facilitating services in a WC case, including but not limited to TPA document uploads 50-3, attorney communication 50-4, employee communication 50-5, and task and action ranking 50-6.

In one aspect, the TPA Module 50 can provide paperless transactions, reducing paper waste and also assisting the adjuster in the filing and serving processes. The system 100 may receive documents from the adjuster via TPA uploads 50-3, allowing all parties to access relevant and important documents and reducing the time the TPA has to spend searching and responding to routine requests from parties in the WC case.

In another aspect, TPA Module 50 can provide communication options with attorneys via the attorney communication link 50-4, allowing direct messaging with its attorney assigned to the WC case. In addition, the TPA Module 50 provides the adjuster additional options to research an attorney/firm based on panel restriction.

In another aspect, TPA Module 50 can provide communication options with employees via the employee communication link 50-5, allowing the adjuster to receive and send messages with employees initiating the WC claim. The TPA Module 50 can provide the adjuster a communication means by which the adjuster can provide a response to all employee questions in a direct and efficient manner. In addition, the CCMS 100 can facilitate and coordinate the TPA and the PTP/STP to send text messages to employees about upcoming appointments.

In yet another aspect, TPA Module 50 includes a task and action ranking function 50-6, whereby the adjuster is required to take a set of actions within the system 100 in accordance with a set of predetermined ranking requirements generated by the system 100. The ranking function may incorporate other module components of the system and aggregated data received by and/or funneled through the system 100 (through the various modules), ranking tasks and actions taken by the adjuster at certain intervals. In operation, the ranking function may be applied in compliance ranking and be configured to assess the adjuster's actions as compared to the AMA or legal standard (based on AMA Guides or legal standards set by experts in the field). In addition, a numeric scale may be applied to the ranking function, such as a scale of 1-5 or 1-10, with 1 being most compliant and 5 or 10, respectively, being non-compliant. The CCMS 100 may automatically convey to the adjuster via prompts in the TPA Module 50 that the action they are taking is not compliant and the relative relevance of this non-compliance, based on the understood impact by predesignated specialists or authorities, providing the adjuster a reason for non-compliance so that the adjuster can correct the error. Furthermore, the compliance ranking may also be applied to compliance of decisions related to benefit termination and start and benefit calculation.

### TPA Module Compensation Example

The TPA Module 50 may aggregate information related to whether or not the WC claim is legally compensable in the first place. If the WC claim is not compensable, the TPA Module 50 automatically triggers a notice to the adjuster, via prompts or communication messages in the TPA Module 50, that no benefits are due. If the WC claim is compensable, then the TPA Module 50 assesses and determines employee compensation due based on a TPA compensation algorithm for the following benefits:

Mileage 10-21a1: a mileage compensation benefit will be due if 1) the WC claim is compensable AND 2) if the employee submits a request for reimbursement from their registered home address to their elected primary treating physician or authorized secondary treating physician. Mileage will be assessed as being owed or not owed.

Temporary Disability 10-21a2: a temporary disability compensation benefit will be due if 1) the WC claim is compensable AND 2) if the PTP has concluded applicant (i.e., employee initiating the WC claim) is totally temporarily disabled OR 3) if the WC claim is compensable and the doctor has concluded the applicant has work restrictions and the employer cannot accommodate. If both conditions are compliant, temporary disability benefits will due to the employee. Moreover, based on these conclusions, the TPA Module 50 may automatically generate a notification to the TPA adjuster notifying them that benefits are due or not due, and also notifying the adjuster that the WC is compliant by paying or not paying them based on these facts.

Permanent Disability 10-21a3: a permanent disability will be due if 1) the WC claim is compensable AND 2) if the PTP concludes that the applicant has MMI (maximum medical improvement)—where applicant's condition is incurable and/or can no longer be improved. Furthermore, the TPA Module 50 may alert and notify the TPA adjuster that permanent disability is due to the applicant when these two facts are present and may also notify the TPA adjuster of non-compliancy if no permanent disability is being paid when those two factors exist.

AMA Compliance Detection Module

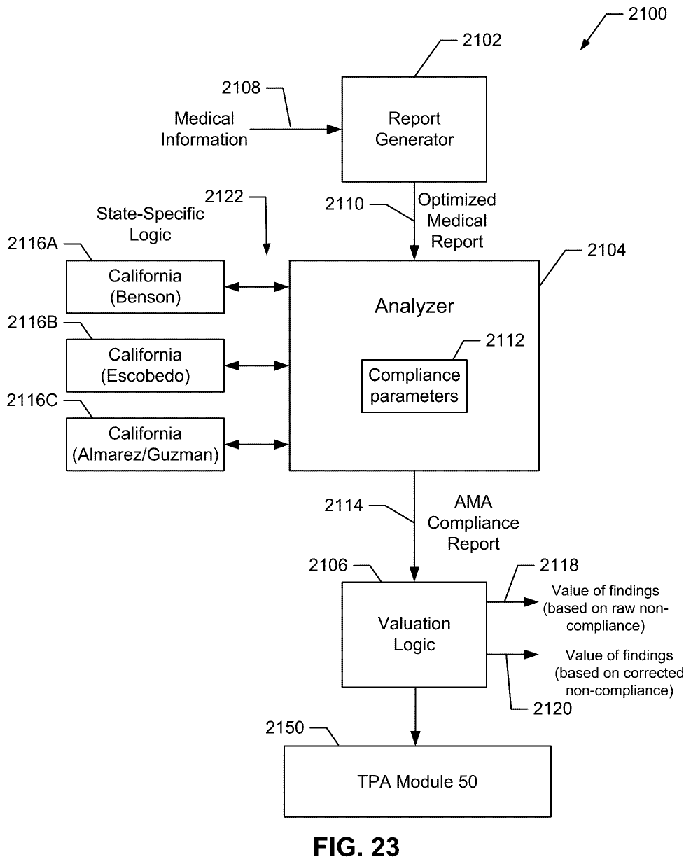

FIG. 23 shows an overview of the AMA compliance detection module 2100 that determines claim compliance based on AMA guidelines, according to an embodiment. In an exemplary embodiment, the compliance detection module 2100 may comprise a report generator 2102, an analyzer 2104, a valuation logic 2106, and one or more state-specific logic blocks 2116.

In an exemplary embodiment, the report generator 2102 receives medical information 2108, processes (converts/translates) this information, and generates an optimized medical report (OMR) 2110.

In an exemplary embodiment, the analyzer 2104 receives the OMR 2110 and processes (determines accuracy and compliance) this report according to compliance parameters 2112 to generate a compliance report 2114. The analyzer 2104 also utilizes state-specific compliance information 2122 from the state-specific logic 2116 to update or modify the compliance report. For example, in the state of California, state-specific decisions based on Benson, Escobedo, and Almaraz/Guzman can be used to update or modify the compliance report. For example, Benson involves the concept of apportioning injury to one body part between two dates of injury. This can be very important whenever there is one body part that overlaps two dates of injury. In an exemplary embodiment, the analyzer 2104 checks to see if the word “Benson” is present in the medical information to see if the medical information discusses “apportionment between dates of injury.” If so, appropriate action will be taken.

Escobedo involves the concept that a medical opinion regarding causation and apportionment must be based on “reasonable medical probability.” In an exemplary embodiment, the analyzer 2104 checks to see if the language “within reasonable medical probability” is used in the medical report when discussing whether the injury was industrially caused (among other things). If so, appropriate action will be taken.

Almaraz/Guzman involves a series of legal cases and opinions that came to be colloquially known as “Almaraz/Guzman Analysis.” These basic principles of law require that the physician do a “strict” reading of the AMA guides when evaluating impairment. For example, if someone suffers from a back condition or injury, then they should be evaluated under the “spine” chapter. However, another series of legal cases exist which suggest that a physician can use his or her medical expertise to evaluate a patient using anything within “the four corners of the AMA Guides.” Some physicians have taken this to mean they can use any part of the AMA Guides they want during their assessment. However, a proper analysis would require the physician to evaluate a patient under a strict reading of the AMA guides. The physician would then have to do an “Almaraz Guzman Analysis” wherein they discuss why the strict reading of the guides is not an adequate reflection of the person's actual condition. Only then can they use another chapter of the AMA Guides as part of their assessment. In an exemplary embodiment, the analyzer 2104 detects whether the doctor performed a strict reading of the AMA guides based on the body part involved. The analyzer 2104 then looks for language in the medical report to discern whether there was discussion as to why the strict reading was “inadequate.” The analyzer 2104 then looks for language as to why another chapter of the AMA Guides is “more appropriate.” These key quoted words, including their synonyms, will be tracked to assess compliance with Almaraz/Guzman and the AMA Guides. It should be noted that the exemplary embodiments are not limited to these three legal holdings and that other states may utilize other applicable state-specific rulings when detecting compliance.

In an exemplary embodiment, the valuation logic 2106 receives the AMA compliance report 2114, processes this report, and generates a value of findings 2118 that is based on raw non-compliance indicators (e.g., discrepancies with the AMA Guides) contained in the compliance report. The value of findings 2118 may directly reflect or correlate to assigned non-compliance levels 1 through 5, with 1 being the least non-compliant (or most compliant) and 5 being severely non-compliant. Non-compliance levels may be based on a predetermined standard set by consensus of experts in the industry. The valuation logic 2106 also generates a value of findings 2120 that is based on corrected non-compliance indicators. The value of findings 2120 may represent the corrected value of an injury claim and/or the amount of money saved by correcting any discrepancies with the AMA Guides. The valuation logic 2106 also may determine or process an impairment percentage parameter. The impairment percentage parameter may directly correlate to a monetary value of the injury claim, as instructed by treatises or statutes, including the Permanent Disability Rating Schedule referenced in the California Labor Code, or an equivalent rating schedule from other states. In yet another embodiment, the AMA compliance report 2114 is subsequently transmitted and conveyed to the TPA Module 50 for analysis and qualification purposes related to benefits determination.

More detailed descriptions of the report generator 2102, analyzer 2104, valuation logic 2106, and one or more state-specific logic blocks 2116 are provided below.

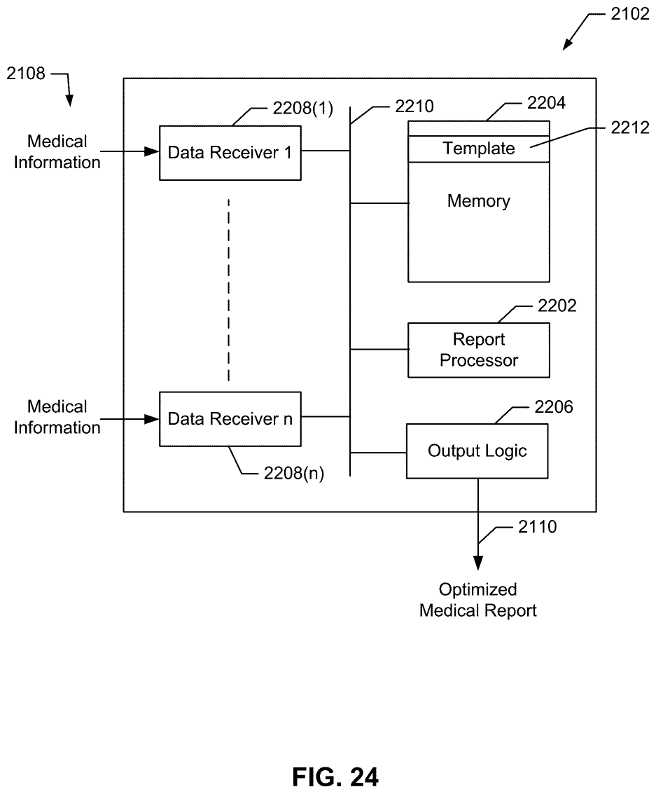

FIG. 24 shows a detailed exemplary embodiment of the report generator 2102 as shown in FIG. 23. In an exemplary embodiment, the report generator 2102 comprises a report processor 2202, memory 2204, output logic 2206 and one or more data receivers 2208. The data receivers 2208 receive medical information for processing. Each of the data receivers 2208 provides a different interface to allow medical data in different formats to be received by the report generator 2102. For example, the data receivers 2208 provide interfaces for the input of medical information through the Internet, Fax, direct text input, document input (such as PDF or text documents), hand-written reports, and/or voice input. Thus, the data receivers 2208 provide virtually any type of interface that can be used to input medical information.

In an exemplary embodiment, the report processor 2202 controls the data receivers 2208 to receive the medical information and convert and store this information as text in the memory 2204. The processor 2202 then translates/converts the text information stored in the memory 2204 into an optimized medical report based on a stored template 2212. The output logic 2206 outputs the OMR 2110. The OMR 2110 also may include an impairment parameter received in the medical information.

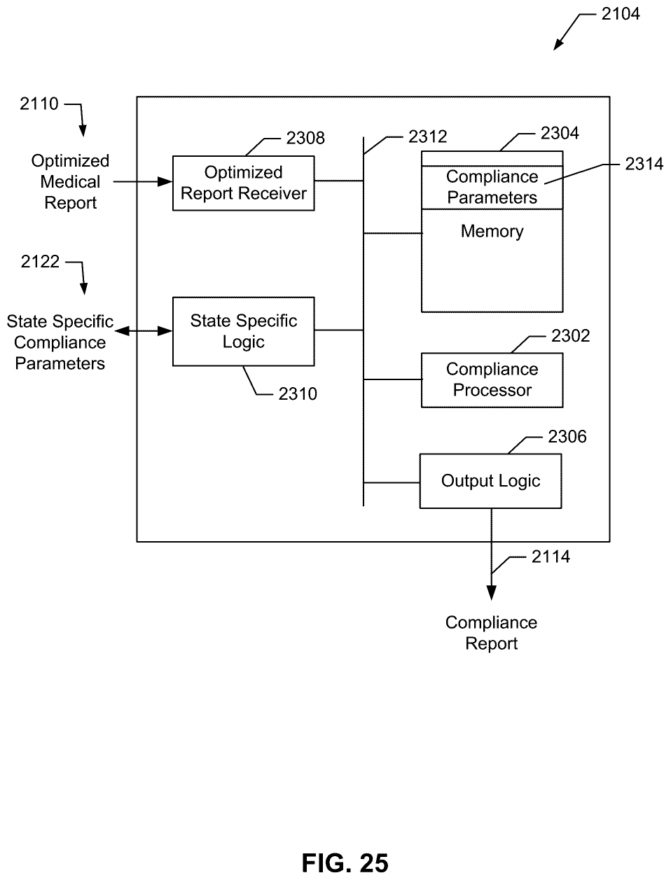

FIG. 25 shows a detailed exemplary embodiment of the analyzer 2104 as shown in FIG. 23. In an exemplary embodiment, the analyzer 2104 comprises a compliance processor 2302, memory 2304, output logic 2306, report receiver 2308, and state-specific logic 2310. The report receiver 2308 receives the optimized medical report 2110 for processing.

In an exemplary embodiment, the compliance processor 2302 analyzes the received OMR 2110 according to compliance parameters 2314 stored in the memory 2304 to generate a compliance report. The compliance processor 2302 controls the state-specific logic 2310 to obtain parameters that can be used to update the compliance report with state-specific compliance information. The output logic 2306 outputs the compliance report 2114.

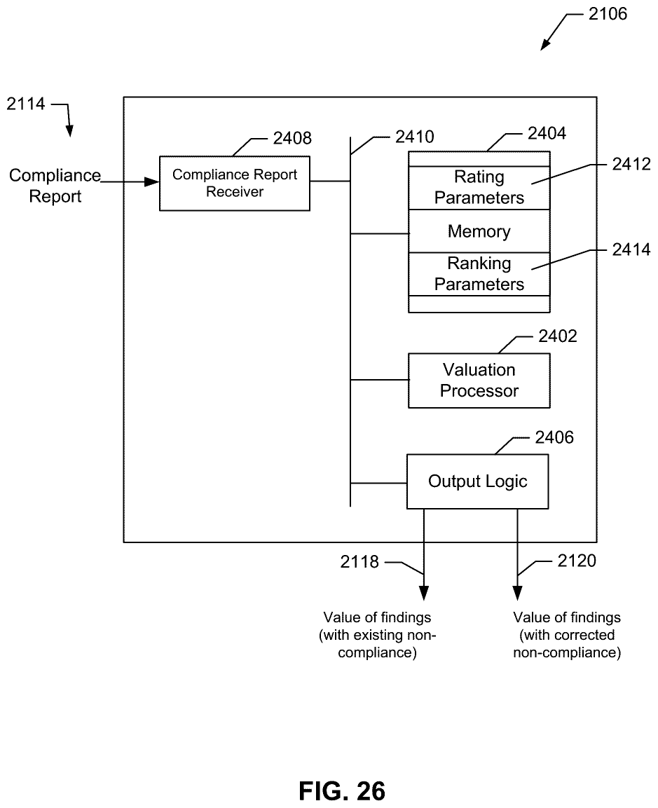

FIG. 26 shows a detailed exemplary embodiment of valuation logic 2106 as shown in FIG. 23. In an exemplary embodiment, the valuation logic 2106 comprises a valuation processor 2402, memory 2404, output logic 2406, and compliance report receiver 2408. The compliance report receiver 2408 receives the compliance report 2114 for processing.

In an exemplary embodiment, the valuation processor 2402 analyzes the received compliance report 2114 according to ranking parameters 2412 stored in the memory 2404 to rank non-compliance indicators contained in the report 2114. For example, the valuation processor 2402 extracts non-compliance information from the compliance report 2114 and this information is ranked according to the ranking parameters 2414. The valuation processor 2402 also generates valuations of the findings based on rating parameters 2412. In an exemplary embodiment, the valuation processor 2402 uses the extracted non-compliance information to generate a value of findings 2118 that is based on raw non-compliance indicators (e.g., discrepancies with the AMA Guides) contained in the compliance report. The value of findings 2118 may be directly correlated with assigned non-compliance levels 1 through 5, with 1 being compliant and 5 being severely non-compliant. The valuation processor 2402 may also correct or modify one or more non-compliance indicators to generate a second value of findings that correlate to corrected non-compliance 2120. The second value of findings 2120 may represent the corrected value of an injury claim or the amount of money saved by correcting any discrepancies. The output logic 2406 outputs the findings 2118 and 2120. In an exemplary embodiment, the valuation processor 2402 also determines an impairment value that can be compared to an impairment value determined by an examining physician.

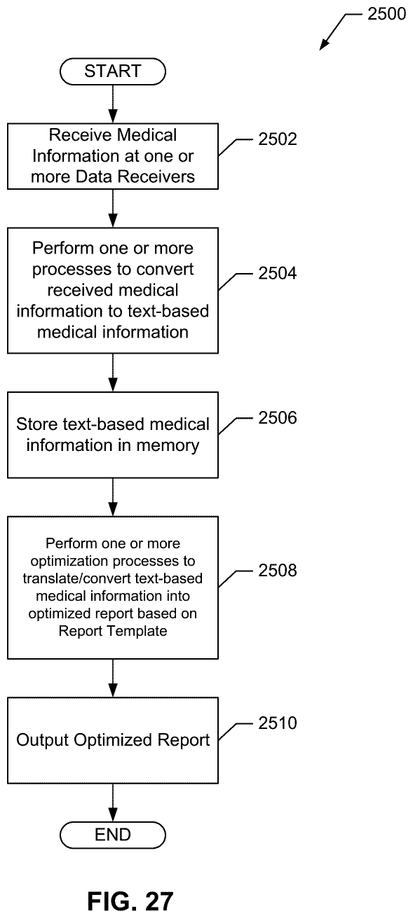

FIG. 27 shows an exemplary embodiment of a method 2500 for operating a report generator to receive medical information and generate an optimized medical report.

At block 2502, medical information is received. For example, the medical information is received by one or more data receivers 2208.

At block 2504, the medical information is converted to text-based information.

For example, the report processor 2202 converts the received medical information to a text-based format.

At block 2506, the converted information is stored in a memory. For example, the report processor 2202 stores the text-based information in the memory 2204.

At block 2508, one or more processes are performed to translate/convert the text-based information to an optimized medical report using a stored template. For example, the report processor 2202 translates/converts the text-based information into an optimized medical report based on the template 2212.

At block 2510, the optimized medical report is outputted. For example, the output logic 2206 outputs the optimized medical report 2110.

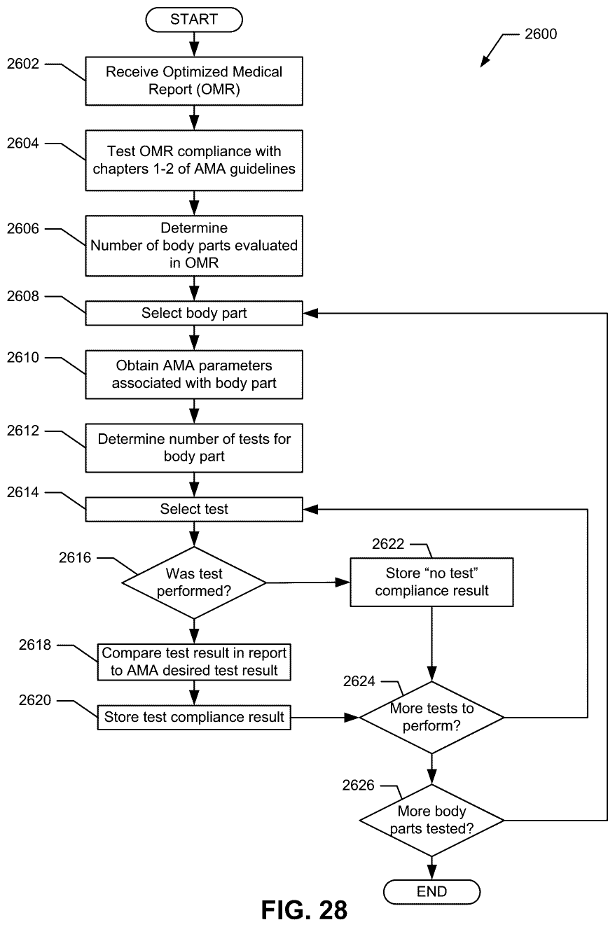

FIG. 28 shows an exemplary embodiment of a method 2600 for operating an analyzer to receive an optimized medical report and generate a compliance report.

At block 2602, an optimized medical report is received. For example, the OMR 2110 is received by the optimized report receiver 2308.

At block 2604, a test is performed on the optimized medical report to test compliance with chapters 1 and 2 of the AMA Guides. For example, the compliance processor 2302 performs this test. A high level assessment of AMA Guides chapters 1-2 for non-compliance may greatly affect overall results.

At block 2606, a number of body parts to be evaluated is determined from the optimized medical report. For example, the compliance processor 2302 determines the number of body parts from the received OMR 2110.

At block 2608, a body part is selected. For example, the compliance processor 2302 selects a body part to evaluate.

At block 2610, AMA compliance parameters associated with the body part are obtained. For example, the compliance processor 2302 obtains the AMA compliance parameters from the parameters 2314 stored in the memory 2304.

At block 2612, a number of tests to be performed for a particular body part is determined. For example, the compliance processor 2302 determines the number of tests from the compliance parameters 2314 stored in the memory 2304.

At block 2614, a particular test is selected. For example, the compliance processor 2302 selects a particular test to be evaluated based on the compliance parameters 2314.

At block 2616, a determination is made as to whether a particular test was performed. For example, the compliance processor 2302 determines whether the particular test was performed based on information in the OMR 2110.

At block 2618, a comparison is made between a test result and a corresponding AMA desired test result. For example, the compliance processor 2302 compares test results in the received OMR 2110 with desired results contained in the compliance parameters 2314.

At block 2620, the compliance result is stored in a memory. For example, the compliance processor 2302 stores the result of the comparison in the memory 2304.

At block, 2622, a “no test” compliance result is stored in a memory. For example, the compliance processor 2302 stores the “no test” information in the memory 2304.

At block 2624, a determination is made as to whether more tests for a particular body part need to be evaluated. For example, the compliance processor 2302 makes this determination based on information received by the system 100 compared against AMA compliance parameters 2314.

At block 2626, a determination is made as to whether more body parts need to be evaluated. For example, the compliance processor 2302 makes this determination based on information received by the system 100 compared against AMA compliance parameters 2314.

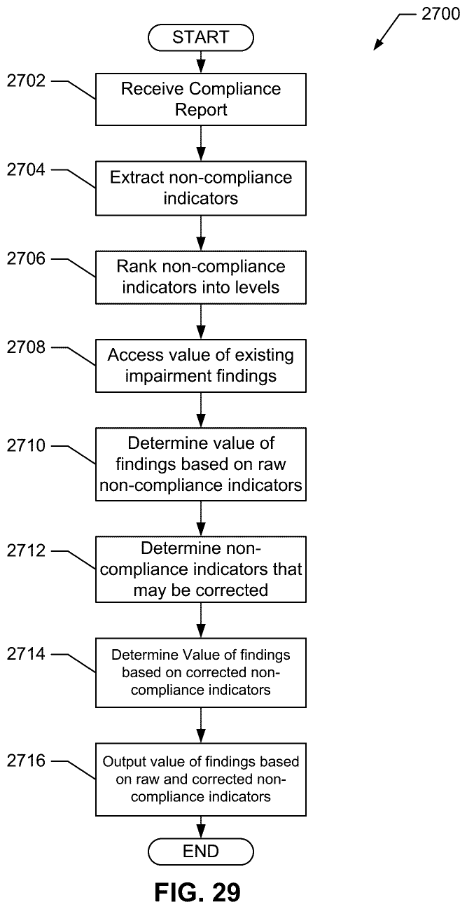

FIG. 29 shows an exemplary embodiment of a method 2700 for operating valuation logic to receive a compliance report and determine a value of findings.

At block 2702, a compliance report is received. For example, the compliance report 2114 is received by the compliance report receiver 2408.

At block 2704, non-compliance indicators are extracted from the received compliance report. For example, the valuation processor 2402 performs this operation.

At block 2706, non-compliance indicators are ranked. For example, non-compliance indicators are ranked between level 1 (compliant) and level 5 (severely non-noncompliant) based on discrepancies with the AMA Guides and a pre-determined analysis of relative relevance of each particular factor. For example, the valuation processor 2402 performs this operation.

At block 2708, values for existing impairment findings are assessed. For example, the valuation processor 2402 runs existing impairment findings, whether compliant or non-compliant, through a rating process to assess valuation.

At block 2710, a value of findings is determined from the extracted non-compliance indicators. For example, the valuation processor 2402 determines the value of findings from the extracted non-compliance indicators.

At block 2712, non-compliance indicators that may be corrected are determined.

For example, the valuation processor 2402 determines non-compliance indicators that may be corrected.

At block 2714, a value of findings is determined from the extracted non-compliance indicators after one or more indicators are corrected or modified. For example, the valuation processor 2402 performs this operation.

At block 2716, one or more value of findings is outputted. For example, the output logic 2406 outputs the value of findings 2118 and 2120.

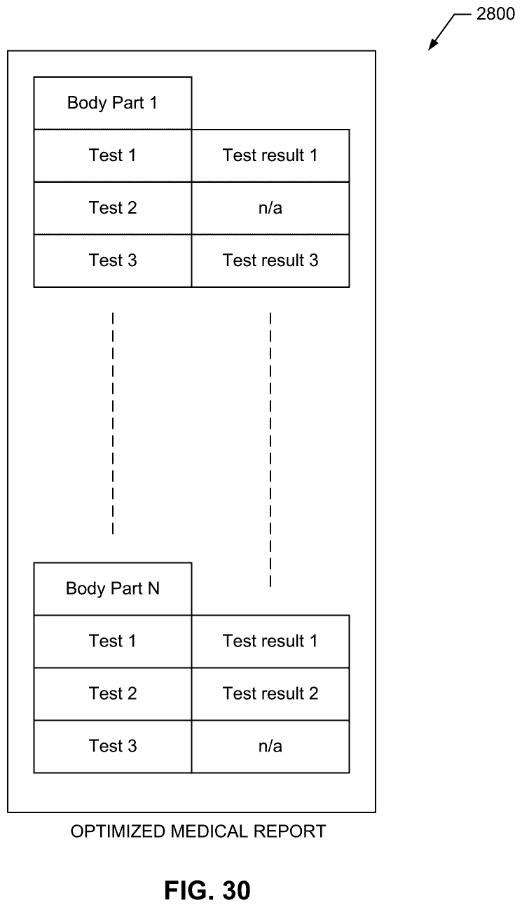

FIG. 30 shows an exemplary embodiment of an optimized medical report 2800 that illustrates how for each body part, tests are identified and the results of those tests are presented. In some cases, the identified test was not performed and so the result is “not available” (N/A).

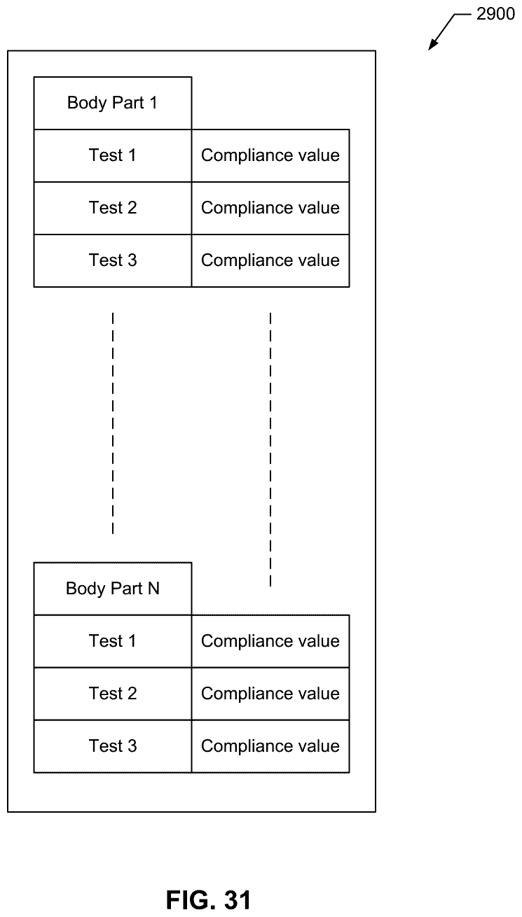

FIG. 31 shows an exemplary embodiment of a compliance report 2900 that illustrates how for each body part, a compliance value is determined for each test. In some cases, the test and/or test result may be in compliance (with respect to the AMA Guides), and in other cases the test and/or test result are not in compliance.

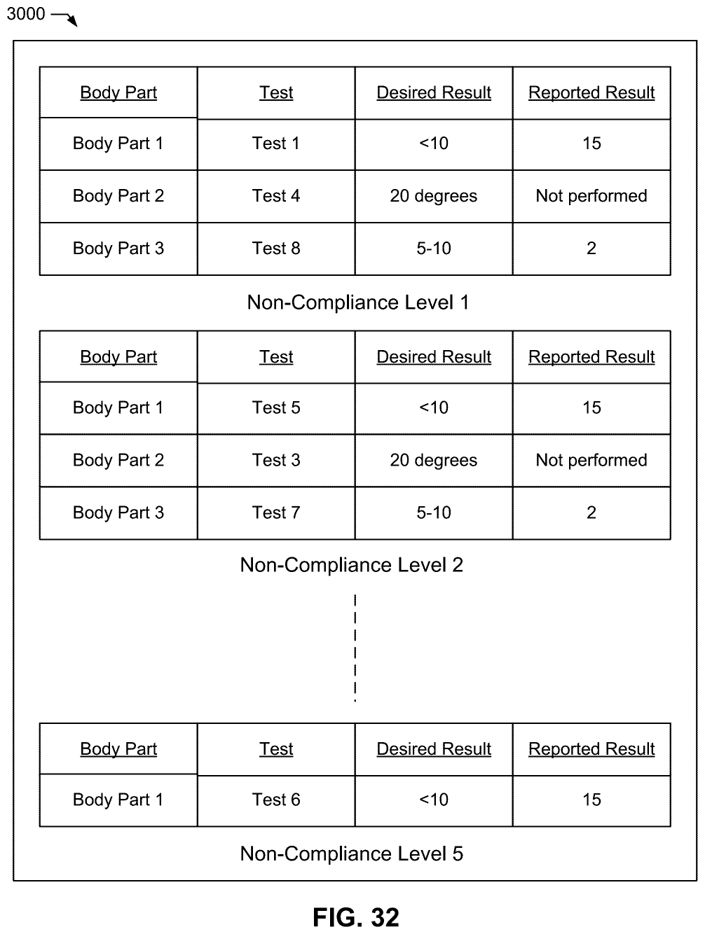

FIG. 32 shows an exemplary embodiment of a value of findings report 3000 that illustrates how tests for different body parts are grouped by compliance levels. Thus, for example, non-compliance Level 1 includes tests performed on body parts 1, 2, and 3.

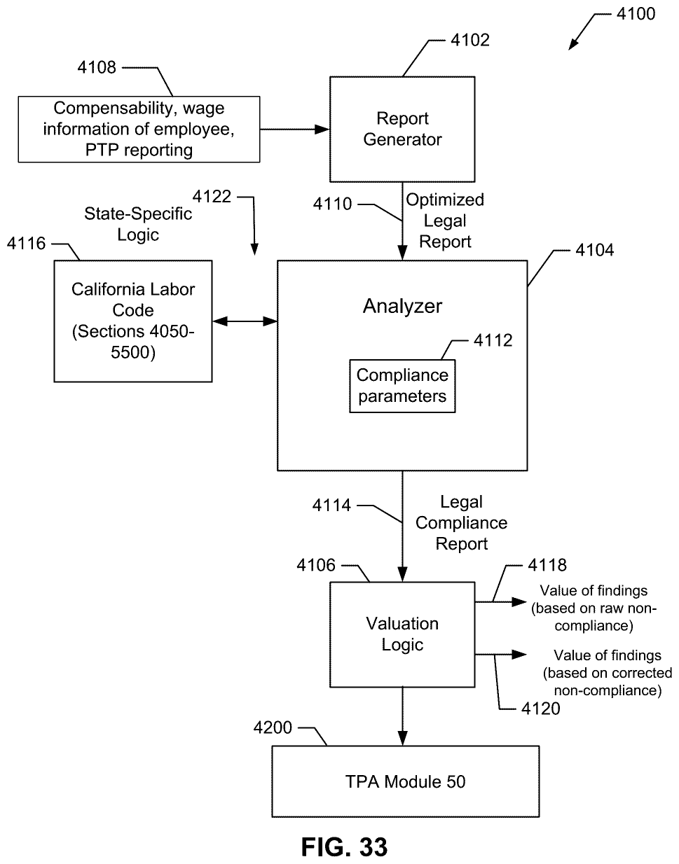

FIG. 33 shows an overview of a legal compliance detection module 4100 of the CCMS 100 for determining claim compliance based on applicable state and government legal codes, according to an embodiment. In an exemplary embodiment, the legal compliance detection module 4100 may comprise a report generator 4102, an analyzer 4104, a valuation logic 4106, and state-specific logic blocks 4116. In another embodiment, the report generator 4102 receives as input a set of WC claim related data 4108, processes (converts/translates) this information, and subsequently generates an optimized legal report (OLR) 4110 (alternatively referred to as an optimized administrative report). In one implementation, the set of WC claim related data 4108 may include: 1) compensability data—whether the claim is accepted or denied for processing; 2) wage information regarding the employee; and 3) reporting of primary treating physician, in order to determine nature and extent of the claimed injury.

In an exemplary embodiment, the analyzer 4104 receives the OLR 4110 and processes (determines accuracy and compliance) this report according to legal compliance parameters 4112 (derived from California Labor Code Sections 4050-5500 or equivalent state-specific labor codes from alternative states) to generate a legal compliance report 4114. The legal compliance parameters are stored in memory, similar to how the AMA compliance parameters are stored in memory. The analyzer 4104 also utilizes state-specific compliance information 4122 from the state-specific logic 4116 to update or modify the legal compliance report 4114. For example, in the state of California, state-specific decisions based on California Labor Code (Sections 4050-5500) can be used to update or modify the legal compliance report. In yet another embodiment, the legal compliance report 4114 is subsequently transmitted and conveyed to the TPA Module 50 for analysis and qualification purposes related to benefits determination.

In application, legal compliance detection module 4100 of the CCMS 100 may assess, determine, and generate a legal compliancy report based on relevant law and on the aggregated data 1 it receives from the CCMS modules (10, 20, 30, 40) as it pertains to the WC claim. In addition, the legal compliance detection module 4100 may assess and determine compliance related to benefits owed to the employee based on the type of benefit and legal compliance thereof, depending on certain factors. For example, these factors may include:

Is temporary disability owed to the employee? (Is paying temporary disability here compliant with relevant law?)

Is permanent disability owed to the employee? (Is paying permanent disability here compliant with relevant law?)

Is mileage owed to the employee? (Is paying mileage here compliant with relevant law?)

Based on internal logic and evaluator components (4102-4120), the legal compliance detection module 4100 may conclude one of three things: 1) No compliance, because case is denied (not compensable in the first place); 2) No compliance, because TPA is missing a piece of information; 3) Yes, the benefit/payment is owed to the employee.

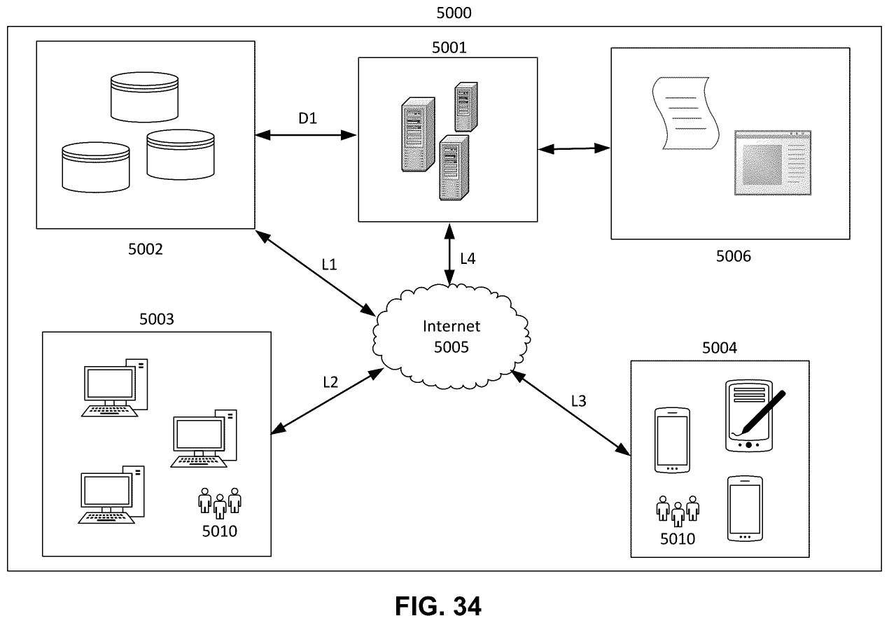

FIG. 34 shows an exemplary system architecture 5000 comprising hardware servers, databases, network devices, and ancillary components under which the CCMS 100 operates and executes programmable instructions and logic to facilitate the handling, communication, execution and resolution of WC claims, according to an embodiment. For example, the system architecture 5000 may include one or more servers 5001 for managing WC cases and having physical resources (processors, operating systems, logic devices, and analyzers) to execute operational instructions and algorithms for each module (10-50) in the CCMS 100. These instructions and algorithms may be stored in a central CCMS database 5002 via a remote network communication link L1 or by a direct communication link D1 connection. In addition, these instructions and algorithms may be implemented on various types of computer-readable medium for carrying one or more module sequences or instructions to processors of the one or more servers 5001 for execution. For example, the instructions may initially be carried on a floppy disk, a hard disk, magnetic tape, or any other magnetic medium, a CD-ROM, an optical medium, a RAM device, memory chips or any other medium from which a computer can read. One or more users 5010 of the CCMS 100 including but not limited to employees, employers, physicians, attorneys and TPA adjusters may access and execute one or more instructions of each module (10-50) via remote computers 5003 and/or remote mobile devices 5004 via network communication links L2, L3, and L4 operating in a global or local cloud system 5005 (i.e., WAN, LAN, Internet, or Intranet). The network communication links (L1-L4) may be implemented in either wired or wireless connection. Aggregated data, including but not limited to WC claim data, communication data, and compliance reports, received by the one or more users 5010 may be stored in the central CCMS database 5002 via a remote networks link L1 and/or L3 through the global or local cloud system 5005. In yet another implementation, the one or more servers 5001 may employ an array of scripting languages 5006 for executing specific tasks and API calls at each module (10-50) and compliance detection modules (2100 and 4100). The scripting languages 5006 may include domain-specific language for a particular environment such as Perl, Python, JavaScript, Visual Basic, and Lisp. Furthermore, an application viewing interface such as a web browser or graphical user interface may be installed on the remote computers 5003 and/or remote mobile devices 5004 for accessing the CCMS 100 via designated portals (p1-p5).

Expanded Functions

In other embodiments, the CCMS 100 may support and integrate expanded functions which expand the capability and operation of the entire system. Some of these expanded functions include but are not limited to the following:
1) An OSHA/Safety Integration Module for supporting OSHA inspectors;
2) An Industrial Clinic module;
3) Built in support for incentives for lien treaters;
4) Built-in support for various languages (English, Spanish, French, and any other language);
5) A monetization module for handling subscription, auto-renewal, multi-year contract, and discounts;
6) A module for viewing QME—experts; and
7) Artificial intelligence AI integration into the various modules for making compliance determinations via statistical analysis and custom algorithms applied to large aggregated data sets related to WC claims.

While particular embodiments of the present disclosure have been shown and described, it will be obvious to those skilled in the art that, based upon the teachings herein, changes and modifications may be made without departing from the exemplary embodiments of the present disclosure and their broader aspects. Therefore, the appended claims are intended to encompass within their scope all such changes and modifications as are within the true spirit and scope of these exemplary embodiments of the present disclosure.

What is claimed is:

1. A computer implemented method comprising:
initiating a workers' compensation session, hosted by a case management server having a plurality of application modules, over a network;
receiving a plurality of workers' compensation data from one or more parties by the case management server, over the network;
aggregating the plurality of workers' compensation data to form an optimized report by the case management server;
analyzing the optimized report by one or more compliance detection modules;
generating a compliance report based on medical guides or legal statutes by the one or more compliance detection modules; and
determining at least one of a first value of findings based on existing non-compliance indicators derived from the compliance report and a second value of findings based on corrected non-compliance indicators derived from the compliance report, wherein the first value of findings and second value of findings are conveyed to at least one of the plurality of application modules for managing and processing one or more workers' compensation cases.

2. The computer implemented method of claim 1, wherein the plurality of application modules comprises at least two of an employee's module, an employer's module, a physician's module, an attorney's module, and a third party administrator's module.

3. The computer implemented method of claim 1, wherein the one or more compliance detection modules comprises an AMA compliance detection module.

4. The computer implemented method of claim 1, wherein the one or more compliance detection modules comprises a legal compliance detection module.

5. The computer implemented method of claim 1, wherein the optimized report comprises an Optimized Medical Report (OMR).

6. The computer implemented method of claim 1, wherein the optimized report comprises an Optimized Legal Report (OLR).

7. The computer implemented method of claim 1, wherein the compliance report comprises an AMA compliance report.

8. The computer implemented method of claim 1, wherein the compliance report comprises a legal compliance report.

9. A system comprising: a communication link; a network interface coupled to the communication link; a processor coupled to the communication link; a memory device coupled to the communication link and holding an instruction set executable on the processor to cause the system to:
initiate a workers' compensation session, hosted by a case management server having a plurality of application modules, over a network;
receive a plurality of workers' compensation data from one or more parties by the case management server, over the network;
aggregate the plurality of workers' compensation data to form an optimized report by the case management server;
analyze the optimized report by one or more compliance detection modules;
generate a compliance report based on medical guides or legal statutes by the one or more compliance detection modules; and
determine at least one of a first value of findings based on existing non-compliance indicators derived from the compliance report and a second value of findings based on corrected non-compliance indicators derived from the compliance report, wherein the first value of findings and second value of findings are conveyed to at least one of the plurality of application modules for managing and processing one or more workers' compensation cases.

10. The system of claim 9, wherein the plurality of application modules comprises at least two of an employee's module, an employer's module, a physician's module, an attorney's module, and a third party administrator's module.

11. The system of claim 9, wherein the one or more compliance detection modules comprises an AMA compliance detection module.

12. The system of claim 9, wherein the one or more compliance detection modules comprises a legal compliance detection module.

13. The system of claim 9, wherein the optimized report comprises an Optimized Medical Report (OMR).

14. The system of claim 9, wherein the optimized report comprises an Optimized Legal Report (OLR).

15. The system of claim 9, wherein the compliance report comprises an AMA compliance report.

16. The system of claim 9, wherein the compliance report comprises a legal compliance report.

17. A computer-readable medium, with instructions which when processed by a computer, cause the computer to: initiate a workers' compensation session, hosted by a case management server having a plurality of application modules, over a network;
receive a plurality of workers' compensation data from one or more parties by the case management server, over the network;
aggregate the plurality of workers' compensation data to form an optimized report by the case management server;
analyze the optimized report by one or more compliance detection modules;
generate a compliance report based on medical guides or legal statutes by the one or more compliance detection modules; and
determine at least one of a first value of findings based on existing non-compliance indicators derived from the compliance report and a second value of findings based on corrected non-compliance indicators derived from the compliance report, wherein the first value of findings and second value of findings are conveyed to at least one of the plurality of application modules for managing and processing one or more workers' compensation cases.

18. The computer-readable medium of claim 17, wherein the plurality of application modules comprises at least two of an employee's module, an employer's module, a physician's module, an attorney's module, and a third party administrator's module.

19. The computer-readable medium of claim 17, wherein the one or more compliance detection modules comprises an AMA compliance detection module

20. The computer-readable medium of claim 17, wherein the one or more compliance detection modules comprises a legal compliance detection module.

21. The computer-readable medium of claim 17, wherein the optimized report comprises an Optimized Medical Report (OMR).

22. The computer-readable medium of claim 17, wherein the optimized report comprises an Optimized Legal Report (OLR).

23. The computer-readable medium of claim 17, wherein the compliance report comprises an AMA compliance report.

24. The computer-readable medium of claim 17, wherein the compliance report comprises a legal compliance report.
